(19) United States
(12) Patent Application Publication
(10) Pub. No.: US 2005/0117033 A1
(43) Pub. Date: Jun. 2, 2005

(54) Image processing device, calibration method thereof, and image processing

(75) Inventor: Shinzo Matsui, Yamanashi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/001,331

(22) Filed: Dec. 1, 2004

(30) Foreign Application Priority Data
Dec. 1, 2003 (JP) 2003-402275

(51) Int. Cl. H04N 5/262

(52) U.S. Cl. 348/239

(57) ABSTRACT

An image processing device includes: an image pickup unit, for forming an image of a target with an optical system, then taking the image using an image pickup device, and obtaining image information including the target; a target-point detecting unit, for detecting a target point where the target exists within a field as position information expressed by information unrelated to the position where the image pickup unit exists; and a relevant information generating unit, for obtaining relevant information representing the correlation between the position information detected by the target-point detecting unit and the direction where the image pickup unit takes an image of the target and/or camera coordinates on the basis of the view angle (i.e., for performing calibration). Thus, the position of the target existing within the three-dimensional field space within an image pickup region where an image of the target is taken by the image pickup unit, can be calculated.

This application claims benefit of Japanese Application No. 2003-402275 filed in Japan on Dec. 1, 2003, the contents of which are incorporated by this reference.

### BACKGROUND OF THE INVENTION

1. Field of the Invention

The present invention relates to an image processing device for cropping an image by tracking a target, a calibration method thereof, and an image processing program.

2. Description of the Related Art

Heretofore, in the event that an image is taken by tracking a target, there has been the need to change the orientation and image pickup size of a camera as the target moves at the time of taking an image of the target. However, with regard to the orientation of the camera, the orientation of a hand-held camera has been changed manually, and the orientation of a large-sized camera has been changed by rotating itself on a camera platform such as a caster serving as an axis of rotation.

On the other hand, a camera operator has changed the image pickup size by manually operating a lens of the camera, or by moving with the camera to change the distance between the target and the camera.

Also, conventionally, a technique regarding a device for subjecting a target image made up of image pickup signals to image processing, and cropping an image including the target, has been disclosed. With this technique, a target is identified by subjecting a specific marker worn by the target to image processing using image pickup signals of a camera, or the like, however, in the event that the target unintentionally conceals the marker, a problem such as a case wherein the target cannot be detected tends to occur.

Now, a device has been disclosed which displays both information obtained by wireless communication and information taken by a camera. According to Japanese Unexamined Patent Application Publication No. 10-314357 for example, positional information images of a ball used in sports and each player, and an image taken by a camera, are displayed on the same screen.

Also, a camera for controlling its platform while tracking a target point has been disclosed. According to Japanese Unexamined Patent Application Publication No. 08-046943 for example, with a television conference system or the like, a subject such as a speaker can be tracked automatically, and also a desired view point can be specified remotely.

On the other hand, the resolution of still cameras and moving image cameras has advanced greatly, enabling shooting of a wide image pickup region such as 8 million pixels.

With shooting in a case such as live television broadcasts of a soccer match, i.e., in a case wherein a target point of shooting moves, a camera operator has performed panning to change the orientation of a camera, and also zooming in/out.

On the other hand, according to Japanese Examined Patent Application Publication No. 08-13099, with an image pickup apparatus in which a finder optical system and a photographing optical system are separately provided for example, the range of an image signal to be displayed on display means can be precisely selected by controlling the correlation between a subject image signal by the finder optical system and a subject image signal to be displayed on display means, thereby eliminating parallax between the finder optical system and the photographing optical system.

Also, according to Japanese Unexamined Patent Application Publication No. 2001-238197 for example, an example is disclosed wherein the position of foreign matter is detected based on output from a sensor such as a microphone, and then the image is cropped.

Furthermore, according to Japanese Unexamined Patent Application Publication No. 2002-290963, an example is disclosed wherein a skier is carrying a cellular phone (GPS receiver, for example) equipped with positional information detecting means, upon the cellular phone transmitting a shooting start command to an image tracking device including image recognizing means, positional information such as GPS data detected by the cellular phone is transmitted to the image tracking device during a tracking image shooting period, i.e., until a shooting end command is transmitted to the image tracing device following the shooting start command being transmitted, and in response to this, the image tracking device detects shooting parameters (shooting direction, shooting magnification) corresponding to the received positional information such as GPS data, and drives and controls a tracking camera driving unit, thereby performing shooting while tracking the skier by means of a tracking camera.

Also, according to Japanese Unexamined Patent Application Publication No. 03-084698, upon any one of a group of sensors such as infrared sensors detecting an abnormal status, a camera having a shooting range corresponding to the detecting range of the sensor is automatically selected from multiple television cameras, an intruder is identified from the shooting images taken by the camera, the identified intruder is displayed on a display unit, or an alarm is given, the movement direction and amount-of-movement of the intruder are obtained from the shooting images, whereby the orientation of a television camera is controlled, and automatic tracking and monitoring is performed.

Also, according to Japanese Unexamined Patent Application Publication No. 2001-45468, an image switching device is disclosed wherein an image selected by information obtained due to coordinates identifying means from images taken by a plurality of image pickup means is output to image display means.

### SUMMARY OF THE INVENTION

An image processing device according to the present invention comprises image pickup means for forming an image of a target by an optical system, taking the image using image pickup devices, and obtaining image information including the target; target-point detecting means for detecting a position where the target exists within a field as positional information represented by information not involved in a position where the image pickup means exist; and relevant information generating means for obtaining relevant information representing the correlation between the position information detected by the target-point detecting means and the camera coordinates on the basis of the direction and/or field angle where the image pickup means takes an image.

Here, the term “field” means one coordinates system wherein a position relative to the target point corresponding to a predetermined reference position of space (region) of which a position can be measured including the target can be calculated as positional information.

According to the present invention, a target is not detected from an image taken by the image pickup means, but the position of a target within a field is detected by target-point detecting means such as a sensor attached to the target, relevant information between the positional information within this field and the camera coordinates on the basis of the direction and/or field angle where the image pickup means takes an image is obtained beforehand (in other words, calibration is performed beforehand), whereby the position within the taken image of the target existing in the three-dimensional field space can be calculated. Thus, if the position within the taken image of the target can be calculated, the image of the target can be cropped from the taken image by tracking the target.

An image processing device according to the present invention comprises image pickup means for forming an image of a target by an optical system, taking the image using image pickup devices, and obtaining image information including the target; target-point detecting means for detecting a position where the target exists within a field as positional information represented by information not involved in a position where the image pickup means exist; and relevant information generating means for obtaining relevant information representing the correlation between the position information detected by the target-point detecting means and image-pickup-device plane coordinates taken by the image pickup means.

According to the present invention, a target is not detected from an image taken by the image pickup means, but the position of a target within a field is detected by target-point detecting means such as a sensor attached to the target, relevant information between the positional information within this field and image-pickup-device plane coordinates taken by the image pickup means beforehand (in other words, calibration is performed beforehand), whereby the position within the taken image of the target existing in the three-dimensional field space can be calculated. Thus, if the position within the taken image of the target can be calculated, the image of the target can be cropped from the taken image by tracking the target.

An image processing device according to the present invention comprises image picked-up data input means for inputting image information including a target obtained by forming an image of the target using an optical system, taking the image; field coordinates input means for inputting the field coordinates of a position where the target exists within a field; and relevant information generating means for obtaining relevant information between the field coordinates input from the field coordinates input means and the coordinates (corresponding to the image-pickup-device plane coordinates) within the image plane in the image information input from the image picked-up data input means.

An image processing program according to the present invention controls a computer so as to function as image picked-up data input means for inputting image information including a target obtained by forming an image of the target using an optical system, taking the image; field coordinates input means for inputting the field coordinates of a position where the target exists within a field; and relevant information generating means for obtaining relevant information between the field coordinates input from the field coordinates input means and the coordinates (corresponding to the image-pickup-device plane coordinates) within the image plane in the image information input from the image picked-up data input means.

### BRIEF DESCRIPTION OF THE DRAWINGS

FIG. 1 is a block diagram illustrating the configuration of an image processing device according to a first embodiment of the present invention;

FIG. 2 is a block diagram illustrating a configuration example of the image pickup means shown in FIG. 1;

FIG. 3 is a block diagram illustrating another configuration example of the image pickup means shown in FIG. 1;

FIGS. 4 through 6 are diagrams describing an example wherein cropping size information is obtained by using the results detected by sensors making up the target-point detecting means shown in FIG. 1;

FIG. 7 is a block diagram illustrating the configuration of an image processing device in an image pickup system including recording and reproducing functions;

FIG. 8 is an explanatory diagram describing the mutual relation between field space and an image pickup region of a camera;

FIG. 9 is an explanatory diagram describing the mutual relation between the field space and the image pickup region of a camera;

FIG. 10 is an explanatory diagram describing the mutual relation between the field space and the image pickup region of a camera;

FIG. 11 is a block diagram illustrating a modification of FIG. 1;

FIG. 12 is a block diagram illustrating the configuration of an image processing device according to a second embodiment of the present invention;

FIG. 13 is an explanatory diagram illustrating in camera space the relation between three position detecting sensors, each pixel of an image pickup device (exists at an theoretical and imaginary CCD position), and a target point;

FIG. 14 is a diagram illustrating image-pickup-device plane coordinates;

FIG. 15 is a flowchart illustrating a pixel position calculation flow for performing coordinates conversion in the sequence of field coordinates, camera coordinates, and pixel coordinates on an image pickup device plane;

FIG. 16 is an explanatory diagram describing an arrangement example of four position detecting sensors at the time of disposing the four position detecting sensors within an image pickup region, and obtaining the conversion matrix of Expression 1 using a distance k0 between the origin of camera space and an image pickup device (exists at an theoretical and imaginary CCD position), a pixel pitch pt of the image pickup device, and the number of pixels;

FIG. 17 is an explanatory diagram describing positional relations at the time of obtaining camera coordinates from each field coordinates of one position detecting sensor within a camera, and two position detecting sensors outside the camera;

FIG. 18 is a flowchart illustrating a flow for obtaining the conversion matrix of Expression 1 using the arrangement example of FIG. 17;

FIG. 19 is a diagram modeling FIGS. 13, 16, and 17, further illustrating an example wherein image pickup magnification α is calculated, and coordinates conversion to an image pickup device plane is performed even in the event that a value equivalent to the distance k0 between the origin of camera space and an image pickup device (exists at an theoretical and imaginary CCD position) is unknown;

FIG. 20 is an explanatory diagram for calculating the image pickup magnification α shown in FIG. 19;

FIG. 21 is a block diagram illustrating the configuration of an image processing device according to a third embodiment of the present invention;

FIG. 22 is a diagram illustrating the relation between the entire output image and a small image obtained by the image pickup means shown in FIG. 21;

FIG. 23 is an explanatory diagram describing the cropping position calculation method shown in FIG. 22;

FIG. 24 is an explanatory diagram describing a calibration method, and illustrating positional relations between a camera and players as viewed from above;

FIG. 25 is a flowchart describing a calibration method;

FIG. 26 is an explanatory diagram describing a modification of the target-point detecting means;

FIG. 27 is a block diagram illustrating the configuration of an image processing device according to a fourth embodiment of the present invention;

FIG. 28 is a block diagram illustrating the configuration of an image processing device according to a fifth embodiment of the present invention;

FIG. 29 is a block diagram illustrating the configuration of an image processing device according to a sixth embodiment of the present invention;

FIG. 30 is a block diagram illustrating the detailed configuration of the image pickup selecting means shown in FIG. 29;

FIG. 31 is, as an example of a sports field such as a soccer field, a plan view illustrating positional relations between cameras and players as viewed from above;

FIG. 32 is, as an example of a hall such as a theater, a plan view illustrating positional relations between cameras and a stage as viewed from above;

FIG. 33 is an explanatory diagram describing a method for detecting a target point using an adaptive array antenna;

FIG. 34 is a diagram describing a method for detecting a target point using the intensity or time difference of airwaves from a cellular phone; and

FIG. 35 is a diagram illustrating a method for obtaining the position of the target point shown in FIG. 34.

### DESCRIPTION OF THE PREFERRED EMBODIMENTS

Description will be made regarding preferred embodiments of the present invention with reference to the drawings.

### First Embodiment

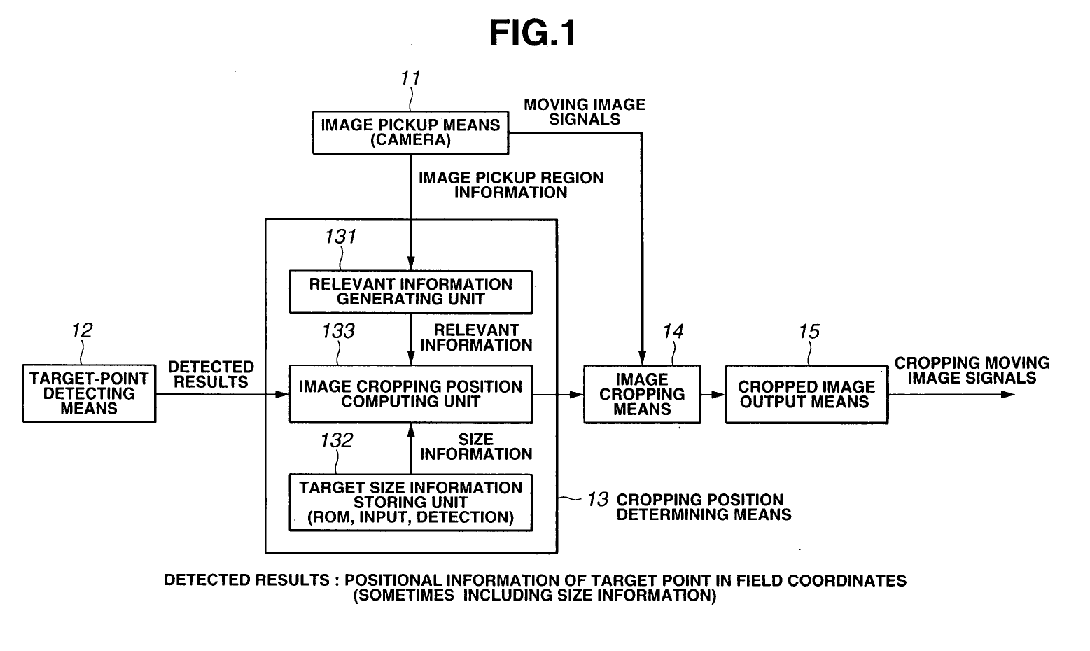

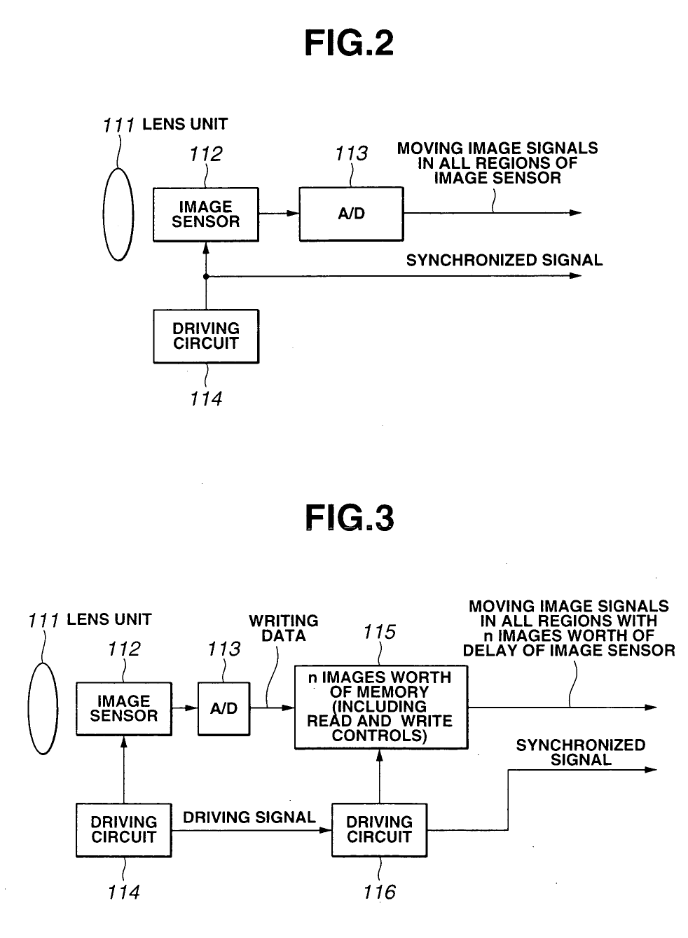

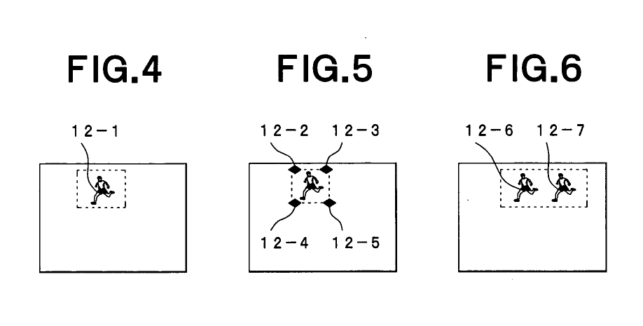

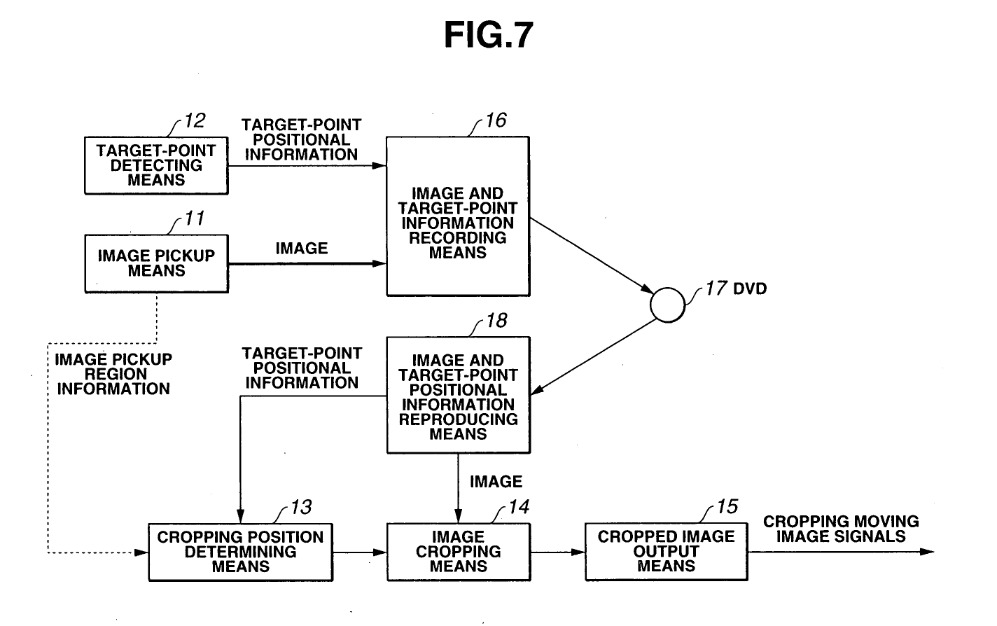

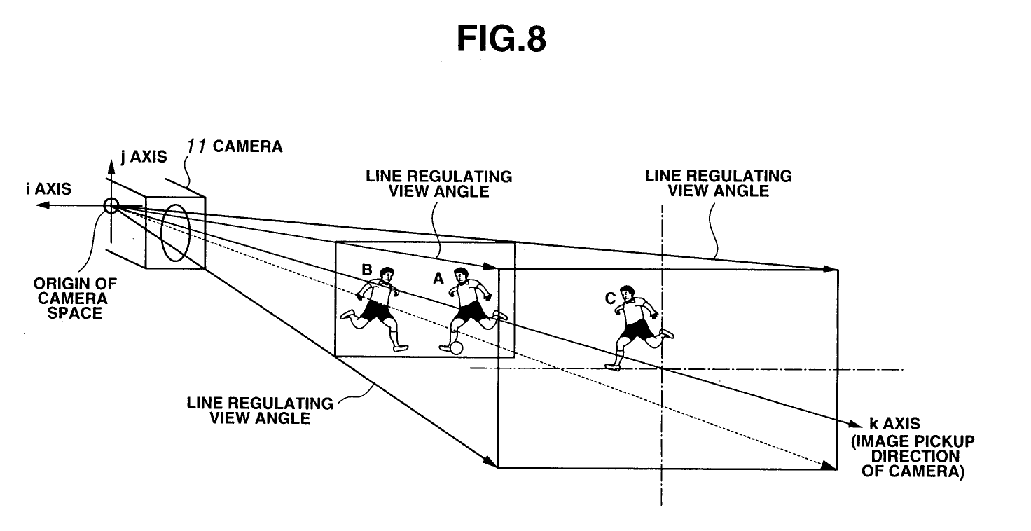

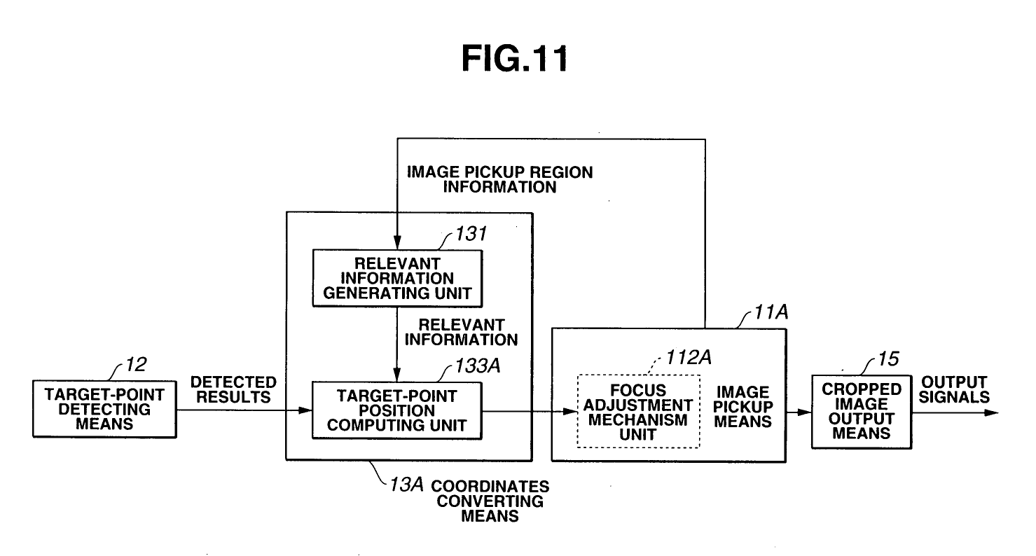

FIG. 1 is a block diagram illustrating the configuration of an image processing device according to a first embodiment of the present invention, FIG. 2 is a block diagram illustrating a configuration example of the image pickup means shown in FIG. 1, FIG. 3 is a block diagram illustrating another configuration example of the image pickup means shown in FIG. 1, FIGS. 4 through 6 are diagrams describing an example wherein cropping size information is obtained by using the results detected by sensors making up the target-point detecting means shown in FIG. 1, FIG. 7 is a block diagram illustrating the configuration of an image processing device in an image pickup system including recording and reproducing functions, FIGS. 8 through 10 are explanatory diagrams describing the mutual relation between field space and an image pickup region of a camera, and FIG. 11 is a block diagram illustrating a modification of FIG. 1.

First, terms employed in the present embodiment and the following embodiments will be defined.

Target: This means an object, subject, or a part thereof to be taken and output with a camera, i.e., means an object of interest.

Target point: This is included in a target, or means a point near a target, an object to be detected with the later-described sensors and so forth. This is not restricted to a single point, and in some cases has a predetermined range depending on the detecting method.

Field space: This is space where a target exists, and means space (region) of which positional information including a target can be detected with the later-described sensors and so forth.

Field coordinates: This means one coordinates system in which the position of a target point or the like existing within field space can be identified as positional information relative to a predetermined reference position within this space, more specifically, means the coordinates system represented as axes X, Y, and Z shown in FIGS. 8 through 10.

Image pickup region: This means an image pickup region for each camera. Also, this is included in the field of view of a camera, further, means a region where a focus adjustment level in the optical system of a camera is equal to or more than a predetermined level. In principle, a camera takes images of objects within the field.

Camera coordinates: This means a coordinates system wherein the point of intersection of lines regulating the view angle in the entire image pickup region of a camera is determined as the origin, and the image pickup direction thereof is assigned to one axis (k), more specifically, means space i, j, and k shown in FIGS. 8 through 10. Here, the term “lines regulating the view angle” means lines three-dimensionally forming an image pickup region to be formed on pixels at the edge of an image pickup device such as a CCD as shown in FIG. 8. With FIGS. 8 through 10 according to the present embodiment, the coordinates system represented with axis i parallel to the horizontal direction of an image pickup device plane, axis j parallel to the vertical direction of the image pickup device plane, and axis k denoting the image pickup direction denotes camera coordinates.

Camera space: This means space in which a position can be identified as to a camera by using camera coordinates.

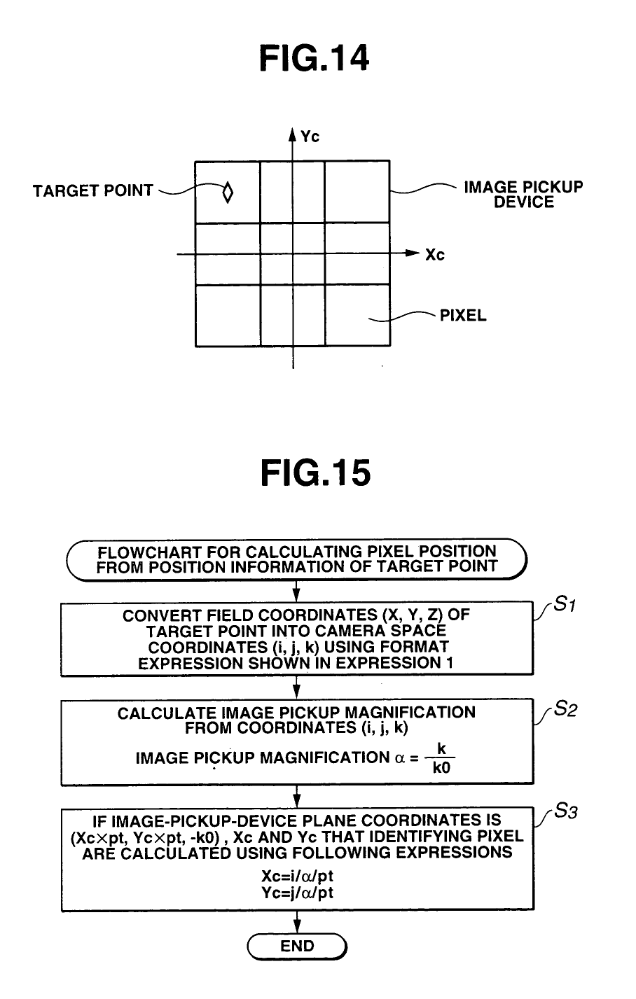

Image pickup device plane coordinates: This means a coordinates system wherein the point of intersection of axis Xc according to the horizontal direction of image data output by an image pickup device such as a CCD and axis Yc according to the vertical direction thereof is the center of the image pickup device serving as the origin (see FIG. 14). However, the position of the origin is not restricted to the center of an image pickup device, so this may be an upper left pixel position.

An image processing device in an image pickup system shown in FIG. 1 comprises image pickup means 11 serving as a camera for taking images of objects within the field space, and outputting moving image signals and image pickup region information, target-point detecting means 12 for detecting the position of a target point within a target, cropping position determining means 13 for determining a cropping position of a target based on the image pickup region information from the image pickup means 11 and the detected results of the target point position from the target-point detecting means 12, predetermined-sized image cropping means 14 for inputting moving image signals from the image pickup means 11, and cropping a predetermined image size from the moving image signals based on the cropping position information from the cropping position determining means 13, and cropped image output means 15 for converting cropped moving image signals with cropped predetermined image size into video signals in accordance with the specifications of a monitor or the like, or into a file format that can be played back on a personal computer or the like, and outputting these.

The image pickup means 11 is configured such as shown in FIG. 2 or FIG. 3.

The image pickup means 11 shown in FIG. 2 comprises a taking lens unit 111 for focusing a subject image on an image pickup plane, an image sensor 112, which is an image pickup device, for subjecting the subject image focused on the entire region on the image pickup plane to photoelectric conversion, and outputting the converted signals as moving image signals for each pixel, an analog-to-digital converting circuit 113 for converting the moving image signals taken by the image sensor 112 into digital signals, and outputting these, and a driving circuit 114 for driving the image sensor 112 by means of a timing pulse including a synchronized signal.

The image pickup means 11 shown in FIG. 3 comprises the taking lens unit 111 for focusing a subject image on an image pickup plane, the image sensor 112, which is an image pickup device, for subjecting the subject image focused on the entire region on the image pickup plane to photoelectric conversion, and outputting the converted signals as moving image signals for each pixel, the analog-to-digital converting circuit 113 for converting the moving image signals taken by the image sensor 112 into digital signals, and outputting these, and the driving circuit 114 for driving the image sensor 112 by means of a timing driving pulse including a synchronized signal, n screens worth of memory (including write and read control) 115 for outputting moving image signals with n screens worth of delay compared to the moving image signals output through the analog-to-digital converting unit 113 from the image sensor, and a driving circuit 116 for driving the n screens worth of memory 115 by means of a second timing driving pulse including a synchronized signal based on the timing driving pulse from the driving circuit 114.

The n screens worth of memory 115 is for generating moving image signals with n screens worth of delay compared to the moving signals from the image sensor, and adjusts n to synchronize with the target-point detecting means 12 and outputs the moving image signals.

The target-point detecting means 12 is means for detecting the positional information of a sensor to be attached to a target such as a GPS (abbreviation of Global Positioning System), or means for detecting the position of a target without attaching a sensor or the like to a target. The detected results of the target-point detecting means are the positional information of a target point within the field coordinates (size information may be included as necessary). However, the target-point detecting means 12 does not include an arrangement wherein the video signals from the image pickup means 11 are directly subjected to image processing, and detects a target. That is to say, the target-point detecting means 12 is detecting means not including the image pickup means 11.

Also, in order that the target-point detecting means 12 detects a target point by means of the above-described sensor, the target-point detecting means 12 needs to include a receiver constituting a base station, or a transmitter as well as the sensor. In the event that a base station is a transmitter, the sensor serving as a receiver detects the position of the sensor corresponding to the position of the base station. On the other hand, in the event that a base station is a receiver, the sensor serving as a transmitter detects the position of the sensor corresponding to the position of the base station.

In the event that the image cropping means 14 crops a part of the entire image of a target of the entire image pickup region from the image pickup means 11, the cropping position determining means 13 is employed to specify the position of the image to be cropped, i.e., the “part of the entire image”, and include a relevant information generating unit 131 serving as relevant information generating means, target size information storing unit 132, and image cropping position computing unit 133.

The relevant information generating unit 131 is generating means for generating relevant information between each position of three-dimensional space of a field and camera space, or relevant information between each position of three-dimensional space of a field and the image-pickup-device plane coordinates of two-dimensional space.

Examples of the relevant information include table information of correlations at the time of converting the field coordinates into the camera coordinates or the image-pickup-device plane coordinates, a coordinates conversion expression indicating the correlation, parameters representing the expression, and so forth.

The target size information storing unit 132 may store the size information of a real target in a field, or may store the size information of a target in a taken image.

The image cropping position computing unit 133 is means for determining a position to crop an image depending on the detected results from the target-point detecting means 12, the relevant information from the relevant information generating unit 131, and the size information of a target from the target-seize information storing unit 132.

In order to determine a region to crop an image, the coordinates position of the field space of a subject to become a target is identified by means of multiple receivers making up the target-point detecting means, coordinates conversion for converting the field coordinates position into the coordinates position (camera space coordinates or image-pickup-device plane coordinates) of the subject as viewed from a camera position is performed, and then the image of the subject portion is cropped.

Here, the field coordinates are converted into the camera space coordinates or the image-pickup-device plane coordinates, which are represented by information unrelated to the position where the image pickup means exist. In the event that the field coordinates position of a subject to become a target can be calculated (detected), the position of the subject is obtained on an image pickup region by the image pickup means, and is supplied to the image cropping means, whereby the subject portion can be cropped from a taken image by the image cropping means.

Next, a case wherein the above-described detected results of the target-point detecting means 12 are size information will be described with reference to FIG. 4 through 6.

FIG. 4 shows an arrangement wherein the size information of a cropping position is a predetermined range centered on one sensor 12-1 of a target. FIG. 5 shows an arrangement wherein target points are four sensors 12-2, 12-3, 12-4, and 12-5 on a field, the positional information of the four positions corresponding to the four sensors is detected, and the size information of a cropping position is a square of which apexes are the four positions. Alternatively, an arrangement may be made wherein a predetermined region according to multiple sensors is set as a cropping region such as obtaining a square with doubled sized of the square as to the center of the square. FIG. 6 shows an arrangement wherein the size information of a cropping position is a predetermined range including two target point sensors 12-6 and 12-7.

FIG. 7 illustrates the configuration of an image processing device including recording and reproducing functions. The difference between the configuration in FIG. 7 and that in FIG. 1 is that the configuration in FIG. 1 is a configuration wherein a cropped image including a target is output at the time of shooting, on the other hand, the configuration in FIG. 7 is a configuration wherein a cropped image including a target is output from an image to be played back following shooting. Components having the same functions as those in FIG. 1 will be denoted with the same reference numerals.

More specifically, with the configuration in FIG. 7, an image and target-point information recording means 16, a DVD 17 which is a recording and reproducing device, and image and target-point positional information reproducing means 18 are provided between a pair of the image pickup means 11 and target-point detecting means 12 and a pair of the cropping position determining means 13 and predetermined-sized image cropping means 14. In the event of recording, an image output from the image pickup means 11 and target point positional information that is detected results from the target-point detecting means 12 are directed to the image and target-point information recording means 16, where the DVD 17, recording and reproducing device is controlled to record the image and target point information. Subsequently, in the event of reproducing, the image and target-point positional information reproducing means 18 controls the DVD 17 to reproduce an image and target point information, the reproduced target point information is supplied to the cropping position determining means 13, and the played-back image is supplied to the image cropping means 14.

FIG. 8 illustrates, in the event that a soccer field is field space, the mutual relation between the field space and an image pickup region of a camera. The image pickup region of the camera is a space region surrounded by four lines regulating the field angle. The point of intersection of the four lines regulating the view angle is the origin of the camera coordinates. Three players A, B, and C exist in the image pickup region of the camera. Axes i, j, and k denote the camera coordinates on the basis of the image pickup direction of the camera, which is the image pickup means 11, and/or the image pickup field angle of the camera. The position of a target point in the image pickup region of the camera can be obtained by using the coordinates of the target point in the field detected with the target-point detecting means 12, and the aforementioned relevant information (a specific example regarding this will be described later).

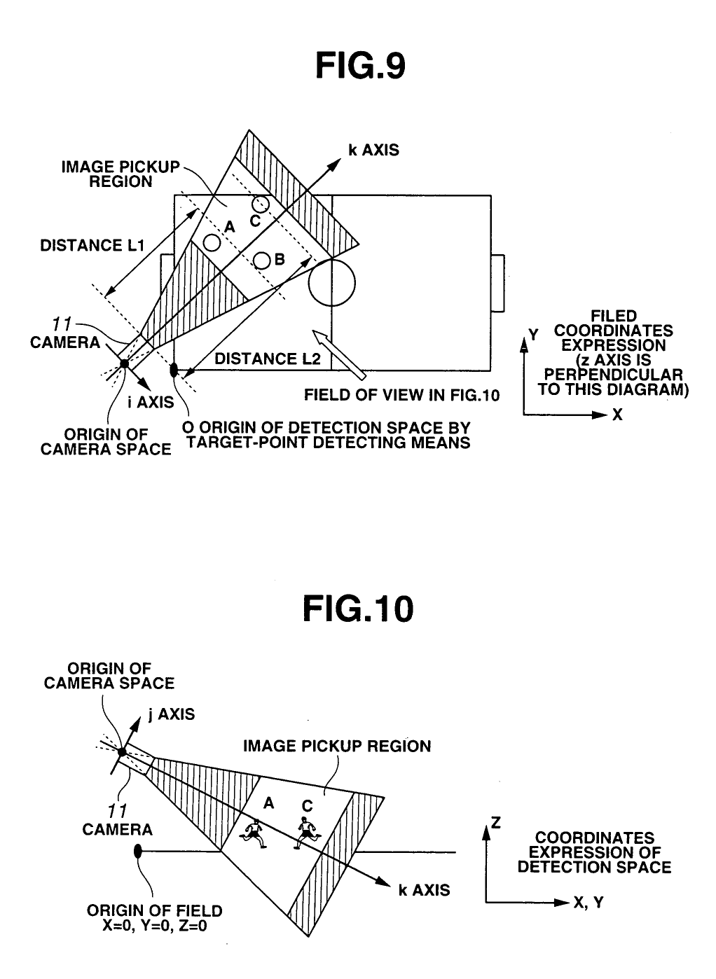

FIG. 9 illustrates the positional relations between the camera and the players as viewed from above FIG. 8. FIG. 10 illustrates the positional relations between the camera and the players when taking a side view of the camera image pickup region surrounded by the lines regulating the field angle in FIG. 9. In this case, the camera should shoot in the lower diagonal direction such that multiple targets are not overlapped. As a result, as shown in FIG. 10, shooting is made such that the players A and C are not overlapped, and the player A does not hide the player C.

FIG. 11 is a modification of FIG. 1 not for cropping an image, and illustrates an example of an image pickup apparatus for adjusting focus of the image pickup means on a target point. In FIG. 11, the cropping position determining means 13 in FIG. 1 is employed as a coordinates converting means 13A. The coordinates converting means 13A comprises the relevant information generating unit 131, and a target-point computing unit 133A for calculating pixel positions in which an image of a target is taken. With this configuration, a focus adjustment mechanism unit 112A of image pickup means 11A can be driven and controlled so as to adjust focus on a target to be detected. The aforementioned driving control is preferably made in accordance with the value of the axis k in the aforementioned camera coordinates.

According to such a configuration, a camera for performing focus adjustment of the target-point detecting means 12 such as sensors on a target such as a person and substance can be realized.

Note that with the aforementioned configuration, positions in which an image of a target is taken are obtained by performing focus adjustment by means of the target-point detecting means 12 and coordinates converting means 13A, but this is not restricted to focus adjustment alone. The target-point detecting means 12 and coordinates converting means 13A in this modification are applicable as position specifying means for various automatic adjustments such as light exposure adjustment and color adjustment.

### Second Embodiment

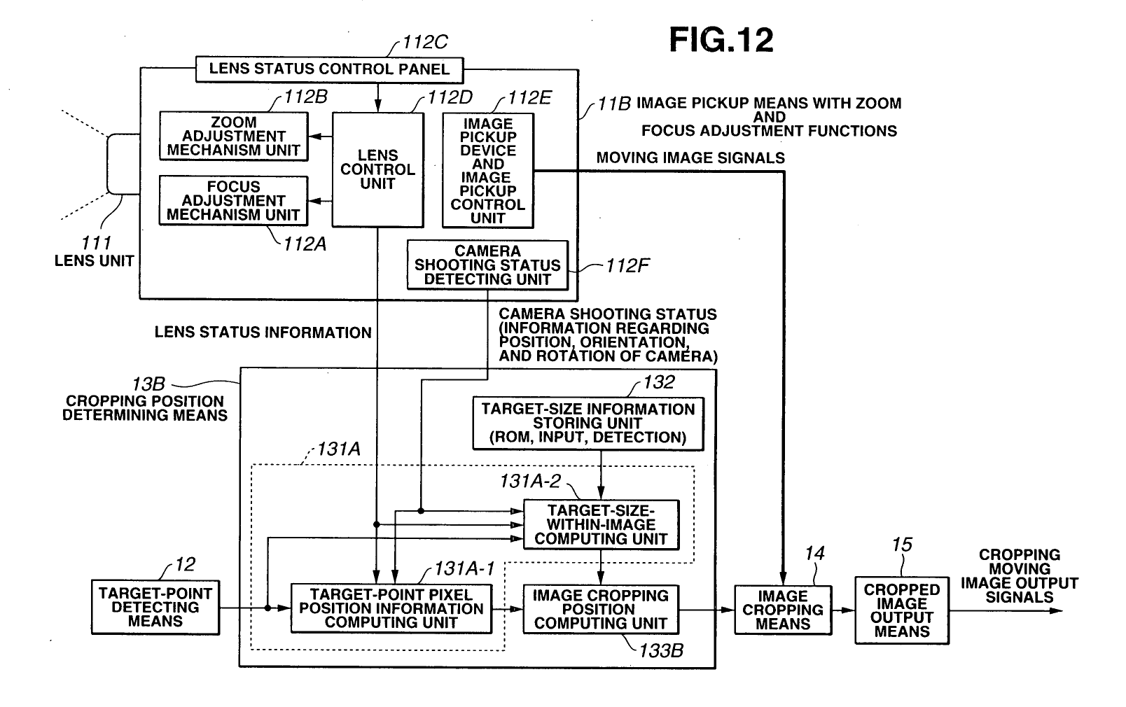

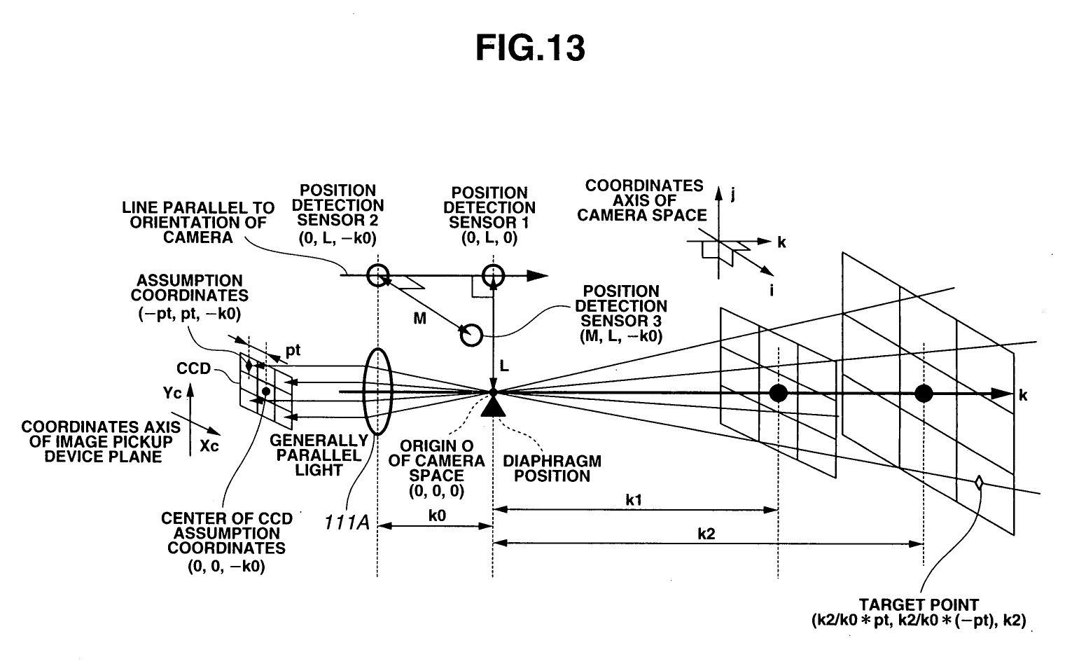

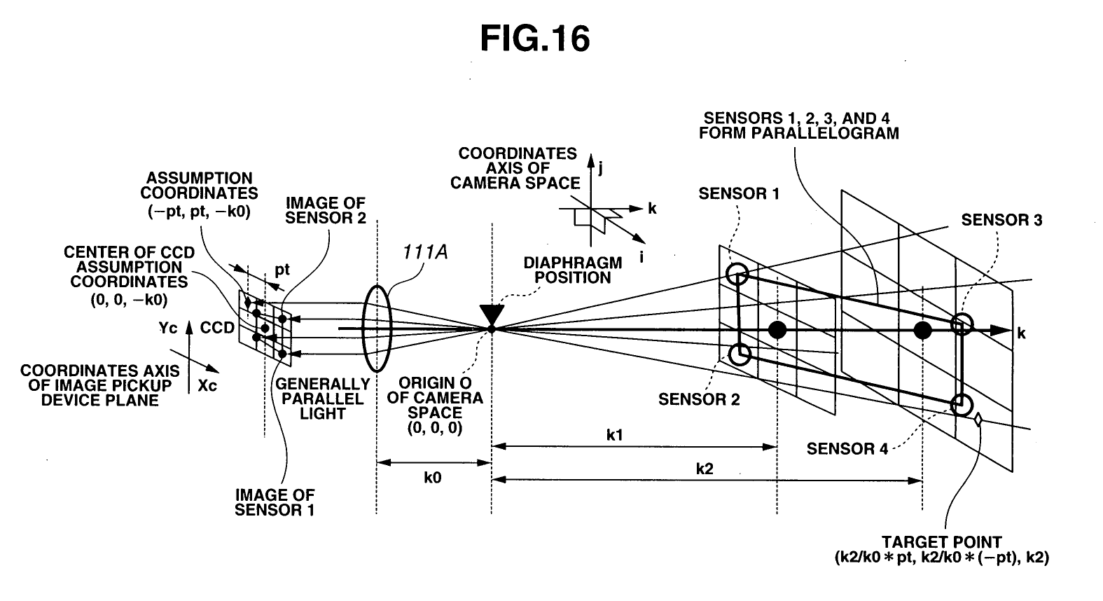

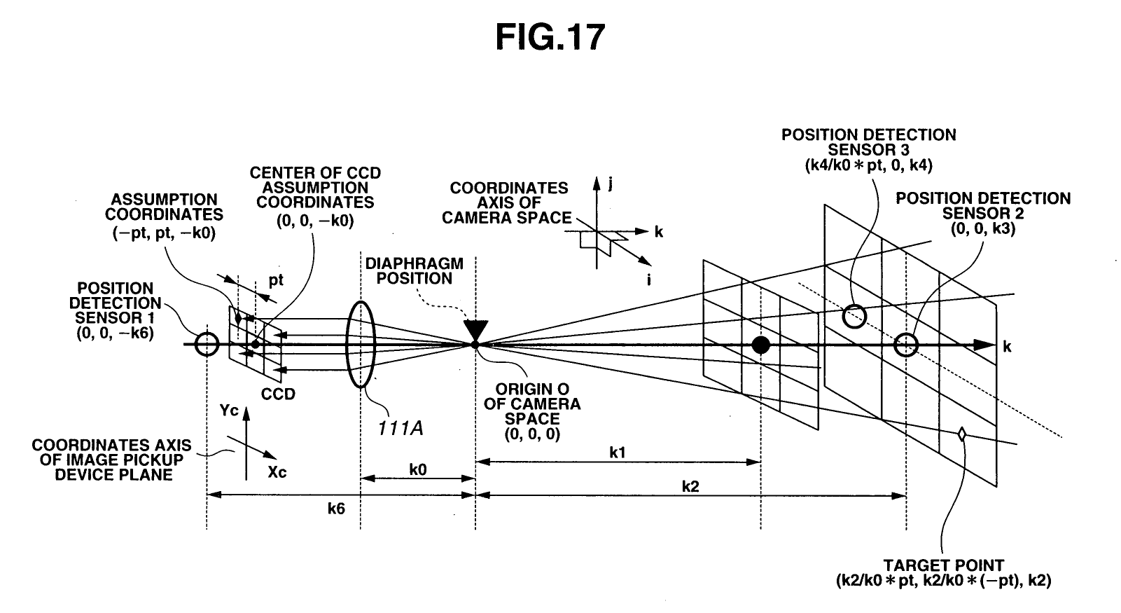

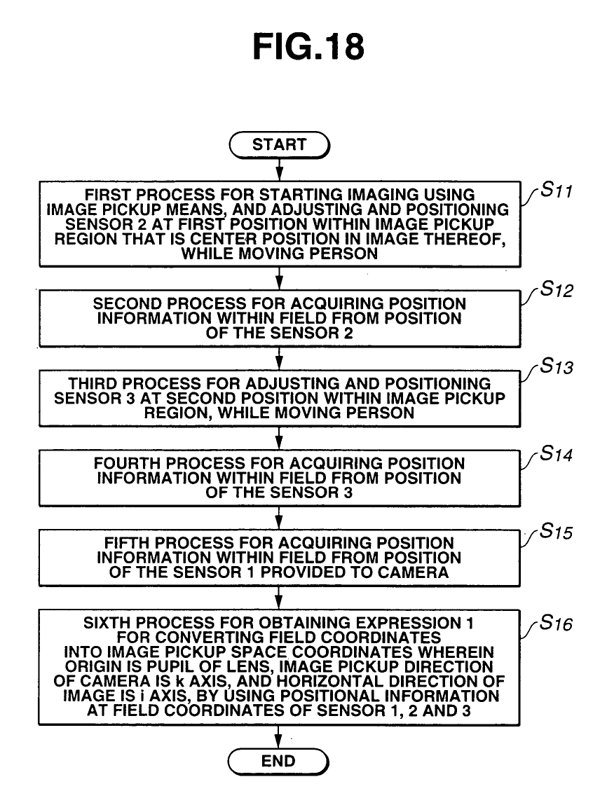

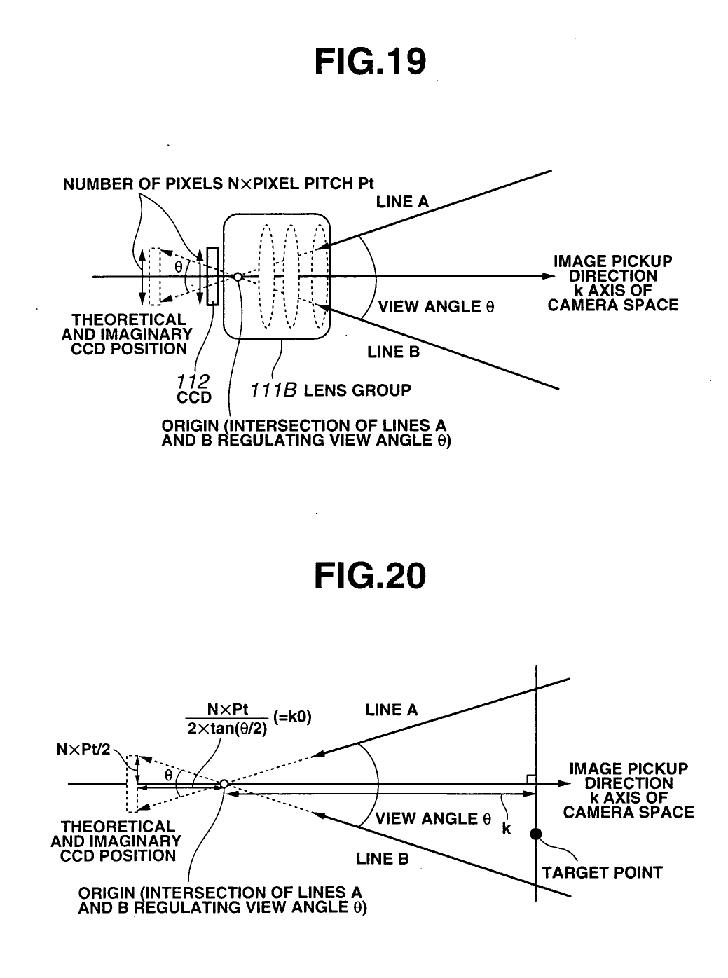

FIG. 12 is a block diagram illustrating the configuration of an image processing device according to a second embodiment of the present invention. FIG. 13 is an explanatory diagram illustrating in camera space the relation between three position detecting sensors of a camera shooting status detecting unit 112F, each pixel of an image pickup device, and a target point. In FIG. 13, the coordinates described within a CCD represent assumption coordinates positioned in a theoretical imaginary CCD at the time of performing the later-described modeling in FIG. 19. FIG. 14 is a diagram illustrating image-pickup-device plane coordinates. FIG. 15 is a flowchart illustrating a pixel position calculation flow for performing coordinates conversion in the sequence of field coordinates, camera coordinates, and pixel coordinates on an image pickup device plane. FIG. 16 is an explanatory diagram describing an arrangement example of four position detecting sensors at the time of disposing the four position detecting sensors within an image pickup region, and obtaining the conversion matrix of Expression 1 using a distance k0 between the origin of camera space and an image pickup device, a pixel pitch pt of the image pickup device, and the number of pixels, and the coordinates described within a CCD in the drawing represent assumption coordinates positioned in a theoretical imaginary CCD at the time of performing the later-described modeling in FIG. 19. FIG. 17 is an explanatory diagram describing positional relations at the time of obtaining camera coordinates from each field coordinates of one position detecting sensor within a camera, and two position detecting sensors outside the camera, and the coordinates described within a CCD in the drawing represent assumption coordinates positioned in a theoretical imaginary CCD at the time of performing the later-described modeling in FIG. 19. FIG. 18 is a flowchart illustrating a flow for obtaining the conversion matrix of Expression 1 using the arrangement example of FIG. 17. FIG. 19 is a diagram modeling the optical configurations of FIGS. 13, 16, and 17, more specifically, a lens 11A is converted into a lens group 111B in which various kinds of lens designs are assumed, and coordinates related to theoretical imaginary CCD position are described as assumption coordinates.

The term “theoretical imaginary CCD position” means that a real-sized CCD is disposed on the extended lines of lines regulating the view angle in the drawing.

In other words, FIG. 19 is a diagram for preventing the ray of light from refraction by the lens group 111B, and being subjected to modeling, and often differs from a real CCD position.

Also, with FIGS. 13, 16, and 17, it is assumed that a numerical value equivalent to a distance k0 between the origin O of camera space and the aforementioned theoretical imaginary CCD position is known. However, even in the event that the numerical value is unknown, as described in FIG. 20, image pickup magnification α can be calculated, and coordinates conversion into image-pickup-device plane coordinates can be performed. FIG. 20 is an explanatory diagram for calculating the image pickup magnification a shown in FIG. 19. Components having the same functions as those in FIG. 1 will be denoted with the same reference numerals.

An image processing device shown in FIG. 12 comprises image pickup means 11B with zoom and focus adjustment functions for taking an image of a target within field space, and outputting moving image signals and image pickup region information; target-point detecting means 12 for detecting the position of a target point within a target; cropping position determining means 13B for determining a cropping position of a target based on the lens status information and camera shooting status information (information regarding position, orientation and rotation of a camera) from the image pickup means 11B and the detected results of a target point position from the target-point detecting means 12; predetermined-sized image cropping means 14 for inputting the moving image signals from the image pickup means 11B, and cropping a predetermined image size from the moving image signals based on the cropping position information from the cropping position determining means 13B; and cropped image output means 15 for converting cropped moving image signals with cropped predetermined image size into video signals in accordance with the specifications of a monitor or the like, or into a file format that can be played back on a personal computer or the like, and outputting these.

The image pickup means 11B with zoom and focus adjustment functions comprise the lens unit 111; the focus adjustment mechanism unit 112A for adjusting the position of a focus lens; a zoom adjustment mechanism unit 112B for adjusting the position of a zoom lens; a lens status control panel 112C for specifying and displaying a lens control status such as a focus status and zoom status; a lens control unit 112D for controlling the focus adjustment mechanism unit 112A and the zoom adjustment mechanism unit 112B for adjustment based on lens control status instructions; an image pickup device and image pickup control unit 112E for controlling an image pickup device and a taken image thereof; and a camera shooting status detecting unit 112F for detecting the position, orientation, and rotation information of a camera.

The camera shooting status detecting unit 112F comprises three position detection sensors such as described in FIG. 13, and the sensors detect each field coordinates. According to arrangement relations shown in FIG. 13, table information or a coordinates conversion expression as the relevant information shown in FIG. 1 can be obtained. Thus, the position O of intersection point of lines regulating the view angle can be detected as a position in the field. Further, the shooting direction of a camera and rotation of a taken image centered on the direction can be detected.

Thus, direction i serving as the horizontal direction of an image to be obtained by the aforementioned point O of intersection of lines regulating the view angle serving as the origin, and direction k serving as the aforementioned shooting direction can be obtained, and consequently, direction j serving as the vertical direction of an image can be obtained.

For those purposes, in FIG. 12, three position detection sensors 1 through 3 are provided, the three sensors detect each position in total three positions, and thus, the aforementioned position O of intersection point of lines regulating the view angle, the aforementioned shooting direction k, and the aforementioned axes i and j can be calculated based on the three positional information.

Note that while description has been made wherein the camera shooting status detecting unit 112F detects three positions of the camera 11B serving as image pickup means, the configuration is not restricted to this. For example, one position information detection of the camera 11B, orientation and rotation detections due to the camera 11B by means of another camera, and the like may be employed.

The target-point detecting means 12 detects positional information in the field. The cropping position determining means 13B include a relevant information generating unit 131A for generating relevant information between each position of three dimensional space in the field and the camera space based on the lens status information from the lens control unit 112D, and the camera shooting status (position of camera, orientation and rotation information) from the camera shooting status detecting unit 112F, or relevant information between each position of three dimensional space in the field and the image-pickup-device plane coordinates of two-dimensional space; the target size information storing unit 132 for storing the size information of a real target in the field, or the size information of a taken image of a target; a image cropping position computing unit 133B for determining a cropping position of an image by using the calculated results of target point pixel position information from the relevant information generating unit 131A, and the size calculated results within an image of a target. The relevant information generating unit 131A comprises a target-point pixel position information computing unit 131A-1; and a target-size-within-image computing unit 131A-2.

The target-point pixel position information computing unit 131A-1 is for calculating image-pickup-device plane coordinates based on the aforementioned positional information of a target point, and for performing coordinates conversion for converting three dimensional field coordinates into image-pickup-device plane coordinates. In other words, the target-point pixel position information computing unit 131A-1 inputs pitch p between pixels of an image pickup device such as a CCD serving as lens status information and camera shooting status information from a camera, the aforementioned three positional information, and a distance k0 from the aforementioned position of intersection point O of lines regulating the field angle serving as lens status information to the center of a collimating lens 111A directing generally parallel light onto an image pickup device plane, and calculates the aforementioned image-pickup-device plane coordinates. Note that it is assumed that a theoretical imaginary CCD position is at the distance k0 from the origin O. Also, it is assumed that the positional relations of the three sensors including-lengths L and M in FIG. 13 are stored in ROM or the like within the target-point pixel position information computing unit beforehand.

The target-size-within-image computing unit 131A-2 calculates the relation between field position information and an image pickup region based on the positional information in the field of the target-point detecting means 12, the positional information and orientation information in the camera field from the camera shooting status detecting unit 112F, and the lens status information from the lens control unit 112D, and calculates the number of vertical and horizontal pixels to be cropped as a cropped image.

FIG. 13 illustrates the positional relation between the three sensors for calculating camera coordinates wherein the position of intersection point of lines regulating the view angle is the origin O, the orientation of a camera is axis k, and the horizontal direction of an image pickup region of a CCD is direction i. Also, the relation between a target point in the camera coordinates and the pixels of a CCD taking an image of the target point is illustrated by means of the camera coordinates.

With regard to the camera coordinates and field coordinates systems, the position detection sensors 1 through 3 of the camera shooting status detecting unit 112F detect coordinates in the corresponding field, each field coordinates corresponding to the origin in the drawing and the center of a CCD can be calculated based on the three known information of L, M, and k0, and arrangement relevant information such as lines connecting each sensor being orthogonal, thus the coordinates conversion expression shown in the format of Expression 1 for converting the field coordinates into the three-dimensional space of the camera coordinates can be obtained.

$$[ \begin{matrix}i \\ j \\ k\end{matrix} ] [ \begin{matrix}p 11 & p 12 & p 13 & p 14 \\ p 21 & p 22 & p 23 & p 24 \\ p 31 & p 32 & p 33 & p 34\end{matrix} ] [ \begin{matrix}x \\ y \\ z \\ 1\end{matrix} ] \qquad [ Expression 1 ]$$

In FIG. 13, the coordinate axes of an image pickup device plane are illustrated as well as the coordinate axes of camera space. FIG. 14 illustrates the coordinate system of an image pickup device plane. The target point (exists on a plane orthogonal to axis k at point k2) in the camera coordinates system in FIG. 13 can be converted into a position on the image pickup device plane coordinate plane represented by (Xc, Yc) such as shown in FIG. 14. While the image pickup devices in FIGS. 13 and 14 have been described as three pixels vertically and three pixels horizontally, it is needless to say that image pickup devices are not restricted to this.

FIG. 15 is a flowchart illustrating a pixel position calculation flow for calculating a pixel position by performing coordinates conversion in the sequence of field coordinates, camera coordinates, and pixel plane coordinates of an image pickup device (CCD) based on the positional information of a target point.

As illustrated in FIG. 15, first, field coordinates (X, Y, Z) of a target point are converted into camera coordinates (i, j, k) by using a format expression shown in Expression 1 (Step S1). Next, image pickup magnification is calculated from the camera coordinates (i, j, k) (Step S2). In other words, this can be obtained by using image pickup magnification α=k/k0. Here, k denotes a distance on the axis k of a plane orthogonal to the axis k including a target point from the origin, more specifically, k1 and k2 are included. In the event of the plane coordinates (Xc×pt, Yc×pt, −k0) of an image pickup device (CCD), Xc and Yc, which identify a pixel, are calculated with the following expression (Step S3). That is to say, Xc=i/α/pt, Yc=j/α/pt.

FIG. 16 illustrates a modification of FIG. 13. With calibration, the position detection sensors 1 through 4 are disposed so as to form a parallelogram within the field space regardless of the orientation of a camera, and each sensor detects its own field coordinates. For example, in the event of a parallelogram in a soccer field, the aforementioned four position detection sensors should be disposed at the four corners of a square goal area. Thus, the conversion matrix in Expression 1 can be calculated based on field coordinates (X₁, Y₁, Z₁), (X₂, Y₂, Z₂), (X₃, Y₃, Z₃), (X₄, Y₄, Z₄) at the sensors 1, 2, 3, and 4, the position of an image taken in the CCD of each sensor, k0, pt, and the number of vertical and horizontal pixels of the CCD.

Note that while the sensors 1, 2, 3, and 4 have been disposed so as to form a square in FIG. 16, in general, they should be disposed so as to form a parallelogram.

FIG. 17 illustrates another modification of FIG. 13. The configuration in FIG. 17 is the same as that in FIG. 12. With this example, a modification of the camera shooting status detecting unit is illustrated.

The camera shooting status detecting unit 112F shown in FIG. 12 includes the three position detection sensors shown in FIG. 13 inside the camera, thus the shooting axes of the camera, rotation of an image, field coordinates of the origin can be calculated, and finally, the aforementioned Expression 1 can be obtained. However, the present modification is not restricted to this configuration, and description will be made regarding another method for obtaining Expression 1 with reference to FIG. 17.

With the present modification, a camera having the position detection sensor 1 capable of detecting a field coordinates position just behind the CCD is employed, and the sensor 2 can be disposed and the positional detection of the sensor 2 can be made by moving a target wearing the sensor 2 to the center of an image pickup region.

It can be understood that the orientation of the camera is the orientation of the position detection sensor 2 from the position detection sensor 1. It is also understood that the origin O is positioned between the sensor 1 and sensor 2, and accordingly, the position at a distance k6 from the sensor 1 that has been already known through design is set as the origin O that is the position of intersection point of lines regulating the view angle, thereby calculating the field position coordinates thereof.

Next, in order to know the rotational direction of an image of the camera, the sensor 3 can be disposed by moving a target wearing the sensor 3 such that the position detection sensor 3 can be disposed at a predetermined pixel position in the horizontal direction of the center within an image pickup region. Thus, obtaining the ratio between a distance i′ in the i direction of the field coordinates of the position detection sensor 3 and a distance Xc′×Pt on the image pickup device plane of a taken image can calculate magnification α.

Note that while FIG. 17 is in the case wherein k3=k4, even if k3 is not identical with k4 shown in FIG. 17, a line passing through the point of the sensor 2, orthogonal to the axis k, and parallel to the axis i can be obtained, and accordingly, a distance from the camera to the sensor 3 is not restricted to a particular distance.

Furthermore, while FIG. 17 is in the case wherein the position detection sensor 3 is disposed within a plane including axes k and i, the position to dispose the sensor 3 is not restricted to this. The sensor 3 may not be disposed within a plane including axes k and i to define rotation as long as it is in an image pickup region.

Thus, the origin, image pickup direction, rotation of an image can be calculated in the field coordinates system, thereby obtaining Expression 1.

As described above, Expression 1 can be obtained not only in an arrangement wherein three position sensors are disposed within a camera such as shown in FIG. 13, but also in an arrangement wherein the one sensor 1 is disposed within a camera, and the two sensors 2 and 3 are disposed at a predetermined position within an image pickup region outside the camera such as shown in FIG. 17.

FIG. 18 illustrates a process leading up to obtaining a coordinates conversion expression for converting the three-dimensional field coordinates into three-dimensional coordinates of an image pickup region by using the arrangement of sensors and configuration shown in FIG. 17.

First, with a first process, taking an image of a target with an camera serving as image pickup means is started, the sensor 2 is disposed while moving and adjusting the sensor 2 at a first position within an image pickup region that is the center position within the image (Step S11). Examples of the adjustment method include a method for detecting the sensor 2 using image recognition, or a method for a person observing an image to be taken using display means.

With a second process, the positional information within the field is obtained from the position of the sensor 2 (Step S12).

With a third process, the sensor 3 is disposed at a second position within an image pickup region while moving and adjusting the sensor 3 (Step S13).

With a fourth process, the positional information within the field is obtained from the position of the sensor 3 (Step S14).

With a fifth process, the positional information within the field is obtained from the position of the sensor 1 disposed within the camera (Step S15).

With a sixth process, Expression 1 for converting into image pickup space coordinates (camera coordinates) wherein the pupil position of a lens is the origin O, the image pickup direction of the camera is axis k, and the horizontal direction of pixels is axis i, is obtained from the positional information within each field coordinates of the sensors 1 through 3 (Step S16).

Subsequently, pixel positions corresponding to the positional information of a target point are calculated by using Expression 1 and following the flow in FIG. 15.

While description has been made in FIGS. 13, 16, and 17 with the configuration of an optical system employing a simple one lens as a model, in reality, configurations include a combination of multiple lenses in most of the cases, and accordingly, in some cases, the relation described in FIG. 15 is not established.

With the aforementioned arrangement, the relation between the size in the field and the size on an image pickup plane can be recognized with a field angle θ uniquely determined by a CCD size defined by the number of pixels N×the pitch pt between pixels, and the distance k0 between the origin and the CCD, image pickup magnification α in Step S2 of FIG. 15 can be calculated, whereby coordinates conversion can be performed. In Step S2, image pickup magnification is calculated with the known k0.

Here, an example will be shown wherein image pickup magnification α is calculated, and coordinates conversion is performed, even if the numerical value equivalent to the k0 is unknown. FIG. 19 illustrates a modification of an optical system model.

In FIG. 19, a field angle θ is determined by the distance between the CCD 112 and the lens group 111B, so the field angle θ is known, whereby image pickup magnification in Step S2 of FIG. 15 can be calculated. FIG. 20 illustrates parameters in the optical system model shown in FIG. 19.

In other words, the image pickup magnification α can be calculated with the following Expression 2 by using the parameters shown in FIG. 20, even if the distance between the CCD 112 and the lens group 111B is unknown.

$$image pickup magnification α = \frac{k}{ko} = \frac{k}{\frac{N \times Pt}{2 \times tan ( θ / 2 )}} = \frac{k \times 2 \times tan ( θ / 2 )}{N \times Pt} \qquad [ Expression 2 ]$$

wherein k represents the distance between a plane including a target point perpendicular to the image pickup direction and the origin.

### Third Embodiment

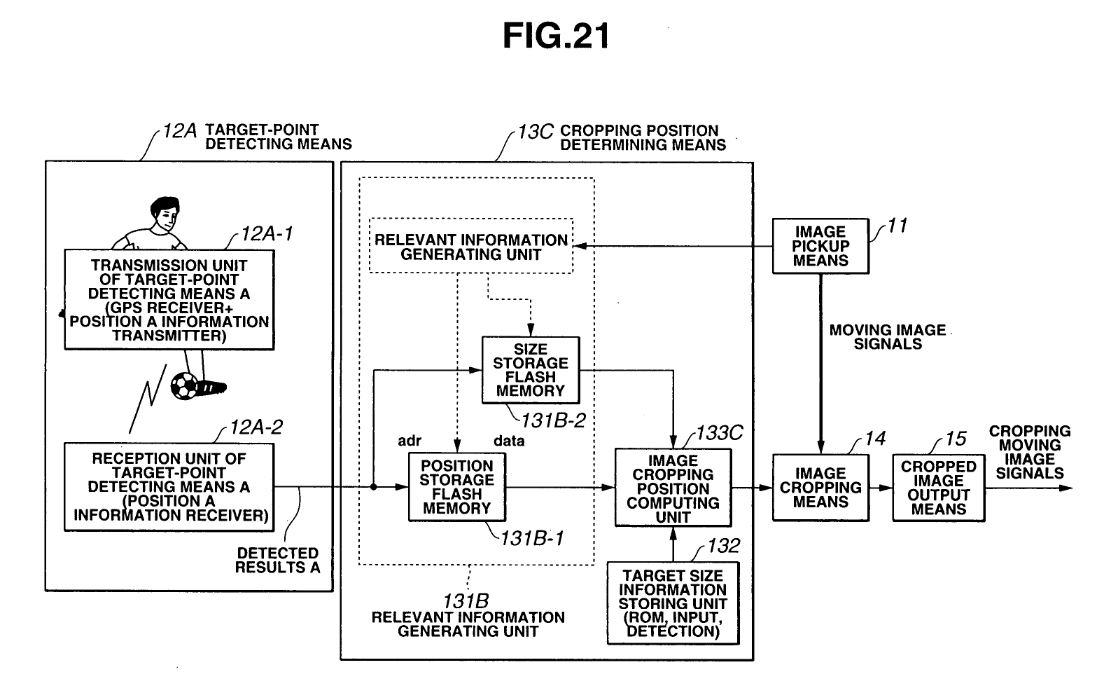

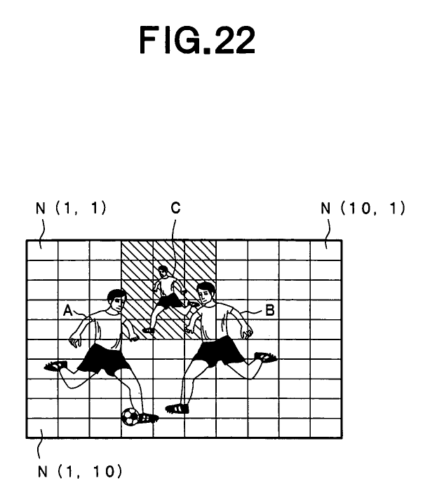

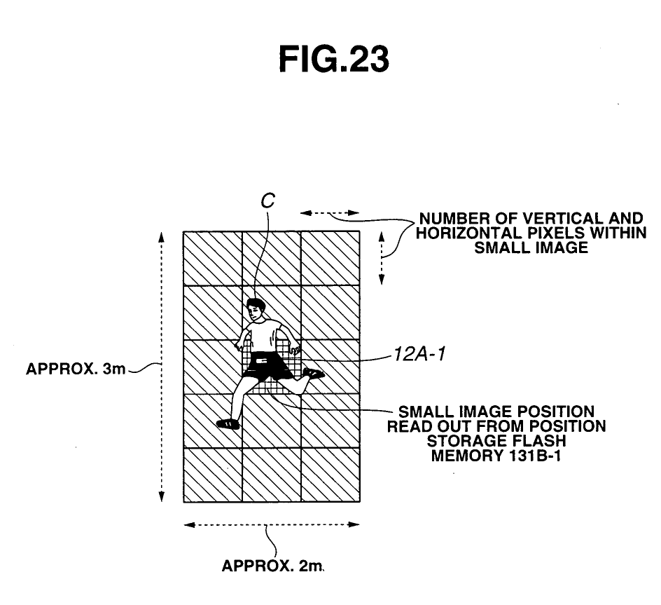

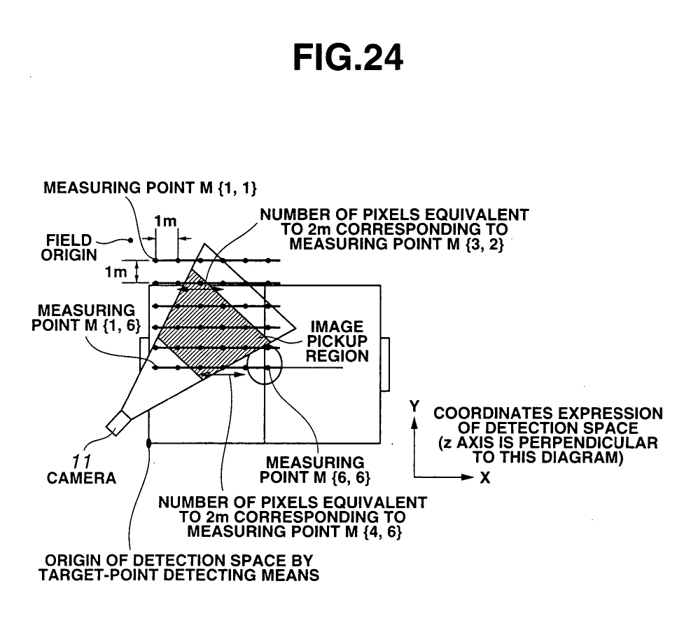

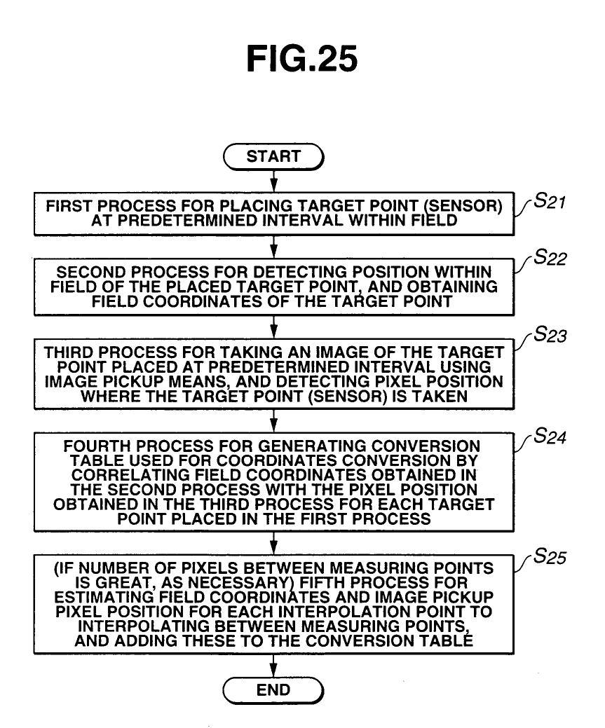

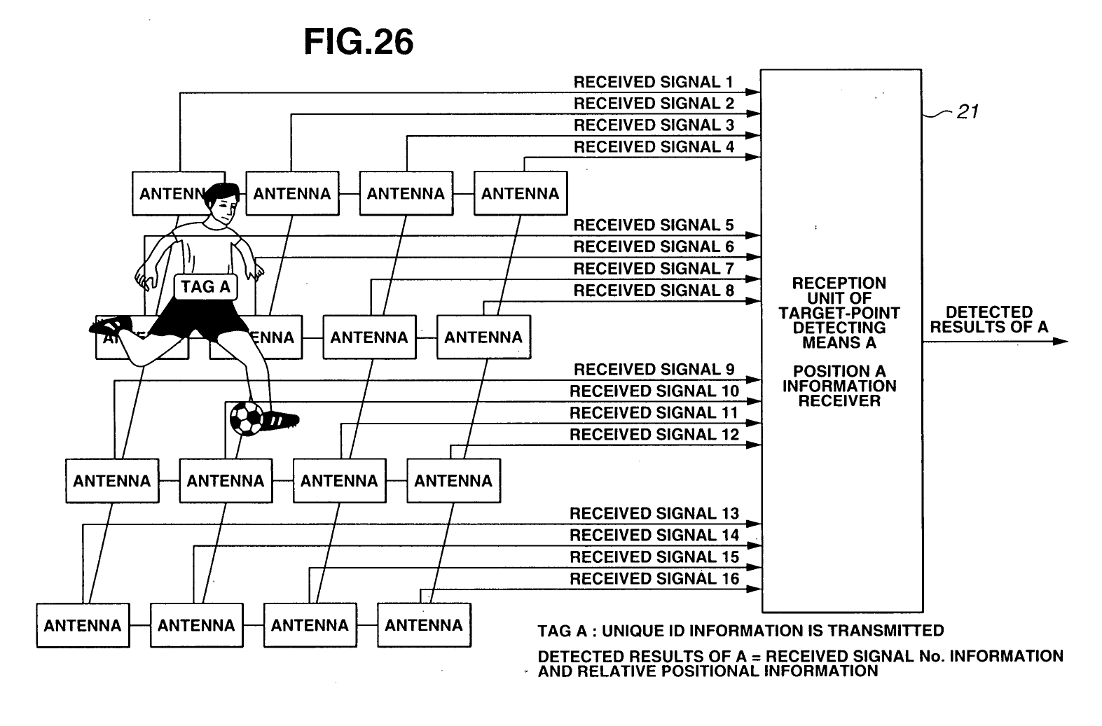

FIG. 21 is a block diagram illustrating the configuration of an image processing device according to a third embodiment of the present invention, FIG. 22 is a diagram illustrating the relation between the entire output image and a small image obtained by the image pickup means shown in FIG. 21, FIG. 23 is an explanatory diagram describing the cropping position calculation method shown in FIG. 22, FIG. 24 is an explanatory diagram describing a calibration method, and illustrating positional relations between a camera and players as viewed from above, FIG. 25 is a flowchart describing a calibration method, and FIG. 26 is an explanatory diagram describing a modification of the target-point detecting means. Components having the same functions as those in FIG. 1 will be denoted with the same reference numerals.

In FIG. 21, an image processing device comprises the image pickup means 11 for taking images of objects within the field space, and outputting moving image signals and image pickup region information, target-point detecting means 12A, cropping position determining means 13C, image cropping means 14, and cropped image output means 15.

The target-point detecting means 12A comprise a transmission unit 12A-1 of target-point detecting means A, and a reception unit 12A-2 of the target-point detecting means A. The transmission unit 12A-1 of the target-point detecting means A comprises a GPS receiver, and a position-A information transmitter for transmitting position-A information obtained by the GPS receiver, for example. The reception unit 12A-2 of the target-point detecting means A comprises a position-A information receiver, for example.

With the GPS receiver in the transmission unit 12A-1 of the target-point detecting means 12A, detailed information regarding latitude and longitude can be calculated as field position information of the receiver. The field position information is transmitted from the position-A information transmitter, received by the position-A information receiver connected to an image cropping control function, according to the cropping position determined by the cropping position determining means 13C, the image cropping means 14 performs cropping of an image from the moving image signals from the image pickup means 11, and the cropped image output means 15 converts the cropped moving image signals into video signals in accordance with the specifications of a monitor or the like, or into a file format that can be reproduced on a personal computer or the like, and outputs these.

While the aforementioned field position information has been described as two-dimensional data of latitude and longitude, with regard to height information, memory (not shown) is provided within the target-point detecting means 12A, a predetermined numerical value is stored therein beforehand, and the value is output from the transmission unit 12A-1.

For example, on the assumption that a sensor is tied around the player's waist, and height information is 90 cm above the field surface where the player stands, the position equivalent to the waist height can be shown. However, height information is not restricted to a predetermined setting value. If there is the need to detect a target point more precisely, height information can be detected by using a GPS or the like. Note that height information is not restricted to being stored within the target-point detecting means 12A. Height information may be stored within the reception unit 12A-2 or cropping position determining means 13C.

The cropping position determining means 13C comprises a relevant information generating unit 131B including position storage flash memory 131B-1 for storing image-pickup-device plane coordinates information corresponding to the detected results at the target-point detecting means 12A, and size storage flash memory 131B-2 for storing the number of pixels indicating how many pixels correspond to 1 m in the i-axial direction and 1 m in the j-axial direction within a plane orthogonal to the axis k of the camera coordinates in the field coordinates position of the detected target point at the time of an image being formed on the image pickup device plane (here, a small image made up of a predetermined number of multiple pixels may be employed instead of pixels, the number of the corresponding small images may be stored instead of the number of pixels); an image cropping position computing unit 133C for calculating a cropping position based on the aforementioned image-pickup-device plane coordinates information corresponding to the detected results of the target-point position information, the number of pixels or small images corresponding to distance of 1 m near a subject A position (including fractions below decimal point), and the size information in the field from the target size information storing unit 132; and the target size information storing unit 132. Note that the size of a subject to be taken becomes smaller as the subject departs from a camera. In other words, there is the need to correct the image pickup size of the subject to be taken according to the distance from the camera to the subject. Subsequently, the “number of pixels or small images corresponding to 1 m” corresponding to a target subject position is read out from the size storage flash memory 131B-2 using the detected results of the target-point detecting means 12A, further the real size (dimension) of the target subject from the target size information storing unit 132. Consequently, at the time of an image of the target subject being formed on the image pickup device plane, determination can be made regarding how many pixels (or small images) are equivalent to the image of the target subject.

Note that the reason why the size information that the target size information storing unit 132 stores is set to the size information of the real target in the field is to facilitate the calculation of the image pickup size obtained depending on the aforementioned distance, taking into consideration the fact that the image pickup size of a target varies corresponding to the distance from a camera. However, the configuration according to the present invention is not restricted to such a configuration, rather, the size information of a taken target image may be stored in the target size information storing unit 132 for each distance from a camera as table data. In this case, there is the need to input the field coordinates position information of the detected target point in the target size information storing unit 132, however, the size storage flash memory 131B-2 is unnecessary.

With the aforementioned configuration, description will be made regarding cropping positions with reference to FIGS. 22 and 23. Hereinafter, description will be made on the assumption that the size storage flash memory 131B-2 stores “number of small images corresponding to 1 m” for each distance from a camera to a subject to facilitate description.

Let us say that each image (block) obtained by dividing the entire image pickup region of the image pickup means 11 into 10 equal parts is a small image. The image cropping means 14 specify a small-image-based cropping region, and perform cropping processing. With the cropping processing, for example, the image cropping means 14 inputs the field position information from the transmission unit 12A-1 of the target-point detecting means 12A tied on near the belly button of the soccer player C in FIG. 22, and performs cropping centered on a small image corresponding to the image-pickup-device plane coordinates information to be read out from the position storage flash memory 131B-1.

Subsequently, the image cropping means 14 determines the cropping size at the time of cropping an image based on the information from the target size information storing unit 132 and the information from the size storage flash memory 131B-2.

Let us consider a specific example now. The image cropping means 14 read out a real size 2.5 m in the vertical direction and 2 m in the horizontal direction sufficient to accommodate the entire body of a player from the target size information storing unit 132 in light of real body height, body build, and the like. Also, the image cropping means 14 reads out information made up of two small images in the vertical direction, and one and half small images in the horizontal direction from the size storage flash memory 131B-2 as information corresponding to distance 1 m near the subject A in FIG. 22.

As a result, the number of cropped small images in the vertical direction is 2.5 (m)×2 (small image/m)=5 (small image). The number of cropped small images in the horizontal direction is 2 (m)×1.5 (small image/m)=3 (small image).

Consequently, a cropped image region specified by 15 small images in total, 5 vertical and 3 horizontal, shown in diagonal lines in FIG. 22 is cropped. This small image-based processing is for realizing a high-speed or low-cost processing system.

Also, a taken-image size of a target corresponding to the distance between a target point and a camera is stored, thereby calculating the most appropriate cropped image region.

Thus, the image cropping position computing unit 133C calculates a cropped image region centered on the aforementioned image-pickup-device plane coordinates information from the position storage flash memory 131B-1.

Note that while description has been made wherein the unit of a cropped image of the image pickup means 11 is set to a small image, the unit of a cropped image is not restricted to a small image. For example, one pixel may be employed instead of a small image.

Next, description will be made regarding a calibration method, i.e., a method for storing the correlation between positional information within an image pickup region of the image pickup means and field position information due to the target-point detecting means.

Description has been made wherein the position storage flash memory 131B-1 and size storage flash memory 131B-2 are for storing the information related to an image pickup region in the image pickup means 11, the correlation between each pixel of an image of the image pickup means 11 and the field position information detected by the target-point detecting means 12A (correlation between positional information), further the number of images within an image pickup region in the image pickup means 11 corresponding to the amount-of-change of a field position A information value. Here, description will be made regarding a method for writing correlation data to each flash memory 131B-1 and 131B-2.

1) The image pickup means 11, which is fixed beforehand, perform adjustment of lens magnification and focus so as to obtain a desired image pickup region.

2) The target point sensors serving as target-point detecting mean 11 made up of a GPS, transmitter, and image recognition marker are disposed on multiple equally spaced measuring points (point (1, 1) through (6, 6), 36 points in total) within the image pickup region shown in FIG. 24 in order, the field position information is obtained from each sensor, further the image-pickup-device plane coordinates for each measuring point, and the image-pickup-device plane coordinates are stored in the memory address of the position storage flash memory 131B-1 corresponding to the field position information from the sensor. Thus, the image-pickup-device plane coordinates are stored in the memory address corresponding to field position information, and accordingly, if field coordinates values are input to the position storage flash memory, the corresponding image-pickup-device plane coordinates can be read out from the position storage flash memory 131B-1. With the aforementioned example, the alignment information of the corresponding small image is stored in the position storage flash memory 131B-1.

3) Next, the number of small images is obtained for each measuring point described above regarding how many small images correspond to a certain distance (1 m, for example) between a certain measuring point and measuring points around the certain measuring point at the time of forming an image on the image pickup device plane, and each obtained number of small images is stored in the memory address of the size storage flash memory 131B-2 corresponding to the field position information of each measuring point. At this time, in the event that a segment between the aforementioned certain measuring point within the field space and measuring points around the certain measuring point is not parallel to the axis i or j of the camera coordinates, the distance between the aforementioned certain measuring point and measuring points around the certain measuring point is converted into a distance in the i-axial direction or j-axial direction of the camera coordinates in light of the aforementioned segment inclined to the axis i or j, and the converted value is preferably stored in the size storage flash memory 131B-2. Note that the number of pixels may be employed instead of the number of small images, as described above.

With the aforementioned example, the number of small images as to a certain distance is stored in the size storage flash memory 131B-2. In the event that a target player is attempted to accommodate within a cropped image, the height and width of the target player are checked, and stored in the target size information storing unit 132 within the device beforehand. The number of pixels corresponding to the height and width of the target player of which an image is formed on the image pickup device plane varies according to the distance between the target player and the image pickup means, i.e., varies according to the field position information. Accordingly, the correction of image cropping size is performed by using “the number of small images or the number of pixels information in each field position information corresponding to a certain distance” stored in the size storage flash memory 131B-2, as described above (FIGS. 21 through 23).

In FIG. 24, let us say that the position of a measuring point and its coordinates in the field are represented as {X, Y}, M {1, 1}, which is 1 m apart in the X and Y directions from the field origin in FIG. 24, is set as a starting point, six measuring points are disposed with 1 m interval in the X direction, and six measuring points, each of which is shown in dot in FIG. 24, are disposed with 1 m interval in the Y direction, and consequently, 36 measuring points in total are disposed, and image-pickup-device plane coordinates are identified for each {X, Y}.

Also, let us say that these 36 measuring points are measured in the j=0 direction, which is height direction, and j=0 means height=0, i.e., measured on the ground, further, the same 36 measuring points are added 2 m above the ground, i.e., three-dimensional 72 measuring points in total including height direction are tightly measured within the image pickup region.

To identify image-pickup-device plane coordinates for each {X, Y} is performed by disposing the following sensors shown in 1) and 2) on the measuring points, and measuring image-pickup-device plane coordinates and field coordinates in the image pickup means 11.

1) A sensor includes a GPS or the like so as to measure coordinates in the field.

2) Also, the sensor includes a marker, which is readily subjected to image processing or user specification as a luminescent or black spot, to detect and identify the position of the sensor from an image in the image pickup means 11. In other words, the marker is preferably a lamp such as a penlight at the time of performing measurement in a dark place, so as to detect image-pickup-device plane coordinates with high luminance within an image.

Conversion can be made directly from field space coordinates to image-pickup-device plane coordinates in accordance with the aforementioned FIG. 24.

FIG. 25 illustrates the basic flow of calibration.

First, as a first process, target points (including sensor) are disposed within the field with a certain interval (Step S21). At a second process, the positions of the disposed target points within the field are detected to obtain the field coordinates of each target point (Step S22).

Next, at a third process, the images of the target points disposed with a certain interval are taken by the image pickup means, the pixels positions where the images of the target points (sensors) are taken are detected (Step S23).

Subsequently, as a fourth process, a conversion table used for performing coordinates conversion is generated by correlating the field coordinates obtained in the second process with the pixel position obtained in the third process for each target point disposed in the first process (Step S24).

Further, as a fifth process, in the event that the number of pixels between the measuring points is great, in order to interpolate between the measuring points, the field coordinates and image pickup pixel position of each interpolation point is assumed and added into the conversion table as necessary (Step S25).

Note that the fifth process is unnecessary in the event of performing measurement tightly. Further, an arrangement may be made wherein interpolation processing is performed in real time at the time of detecting the position of a target point, and accordingly, the fifth process is not an indispensable process.

Note that the conversion expression serving as relevant information and the relevant information generating means for generating table data are not restricted to the aforementioned method.

Table 1 will describe an example method of the respective relevant information generating means described in FIGS. 13, 17 and 16. In addition to Table 1, various methods of the relevant information generating means are available.

TABLE 1
Examples of Relevant Information Generating Means

| | Number of Position Detection Sensors and | | | | | |
|---|---|---|---|---|---|---|
| | Placement Thereof | | | | | |
| Example | | | Disposed in Image | | Reference | |
| No. | Equipped with Camera | | Pickup Region | | Drawing | Advantage |
| 1 | 3 | Two positions | None | Unnecessary | | Calibration is |
| | sets | are on a line | | | | unnecessary. |
| | | parallel to | | | | Even if the |
| | | optical axis | | | | orientation of a |
| | | where optical | | | | camera or lens |
| | | axis direction | | | | power is |
| | | is readily | | | | changed, |
| | | detected, and | | | | relevant |
| | | one position is | | | | information is |
| | | not on the | | | | automatically |
| | | line. | | | | generated. |
| 2 | 1 | The back of a | 2 | On certain two | | The distance |
| | set | CCD or the like | sets | pixel positions | | between the |
| | | on the optical | | in an image of a | | sensor of a |
| | | axis of an | | target, in | | camera and the |
| | | optical system | | combination with | | sensor of an |
| | | is preferable. | | the sensor of a | | image pickup |
| | | | | camera, a | | region is |
| | | | | position where | | relatively apart |
| | | | | optical axis | | from each other |
| | | | | direction, | | in many cases, |
| | | | | rotation of an | | at this time, |
| | | | | image, lens | | relevant |
| | | | | power, and the | | information with |
| | | | | like can be | | high precision |
| | | | | assumed. | | can be |
| | | | | | | generated. |
| 3 | None | Unnecessary | 4 | Each sensor is | | Position |
| | | | sets | disposed at an | | detection sensor |
| | | | | apex of a | | is not necessary |
| | | | | parallelogram | | in camera, and a |
| | | | | within an image | | general-purpose |
| | | | | pickup region. | | camera can be |
| | | | | | | employed. |

In FIG. 24, with calibration, sensors are disposed on multiple positions in the field, and the conversion table for converting the field coordinates from the position information of each sensor into image-pickup-device plane coordinates. Subsequently, when a target attaches a sensor to his/her body and moves, the target point of the target can be converted into a position on image-pickup-device plane coordinates immediately by converting the field coordinates corresponding to the position to be changed according to the movement of the sensor with the aforementioned table.

On the other hand, in FIG. 26, a floor mat in which multiple receiving antennas are arrayed in a matrix state, and buried is put down in the field, the image pickup means 11 detects a target moving on the floor mat to take an image on the floor mat, and the target is detected from the taken image to crop the target from the image.

At this time, as the tag shown in FIG. 26, an IC tag A of RFID (Radio Frequency-IDentification) is employed, a tag (A) position information receiver 21 of the floor mat inputs receiving signals 1 through 12 serving as an address from each antenna, and detects a receiving signal with high intensity, and outputs the receiving signal number information as output information and detected results of A. The detected results of A include receiving signal Number information and relative position information as to the antenna thereof.

The IC tag A comprises a transmission antenna, and an electronic circuit for storing ID information in memory, and transmitting the ID information from the transmission antenna. The ID information transmitted by the IC tag A is unique information.

Also, the position A information receiver 21 receives ID information, and outputs a detected results signal in the event that the received ID information is output from the tag A.

While description has been made wherein the position A information receiver 21 detects a receiving signal having high intensity, receiving signals are not restricted to this.

With a detected results signal which is output according to three high intensity signals and the time difference thereof, an arrangement may be made wherein highest receiving signal information, further, relative position information as to the receiving signal number thereof are calculated according to the time difference information of the three signals by means of triangulation, and the calculated results are output as the detected results signal. Alternatively, the aforementioned calculation may be made based on the intensity difference information of the three signals instead of the time difference information of the three signals by means of triangulation.

Thus, as described with reference to FIG. 21, input information for converting field coordinates information into image-pickup-device plane coordinates may be unique information of which position can be identified such as receiving signal number information.

The relevant information generating unit 131B shown in FIG. 26 which is a modification of that shown in FIG. 21 generates image-pickup-device plane coordinates corresponding to the aforementioned receiving signal number information, and the relevant information thereof is stored in the size storage flash memory 131B-2 or position storage flash memory 131B-1 beforehand.

In other words, the position storage flash memory 131B-1 inputs receiving signal number information, and outputs image-pickup-device plane coordinates corresponding to the receiving signal number information. On the other hand, the size storage flash memory 131B-2 inputs receiving signal number information, and outputs number of pixel information corresponding to a certain length in the image-pickup-device plane coordinates. Thus, the image cropping position computing unit 133C (see FIG. 21) can calculate and output the cropping position of an image so as to include a target.

### Fourth Embodiment

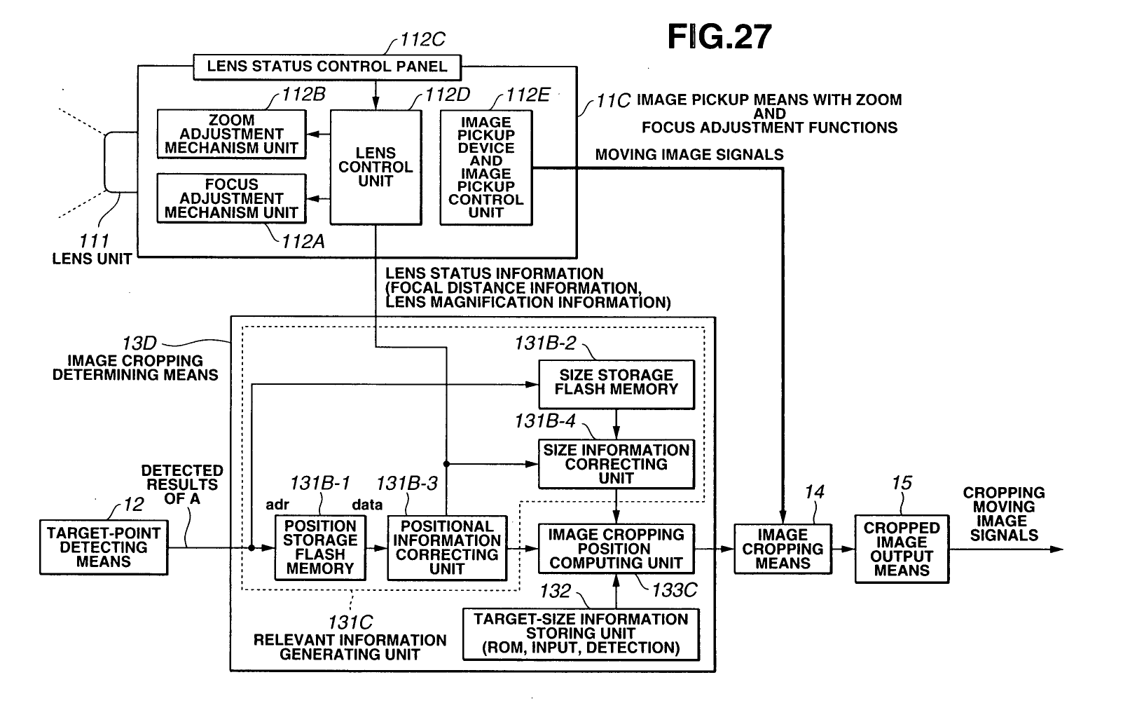

FIG. 27 is a block diagram illustrating the configuration of an image processing device according to a fourth embodiment of the present invention.

The present embodiment is applied to a case wherein lens power or focus position adjustment is changed in the image pickup system in the first embodiment. Components having the same functions as those in FIGS. 1, 12 and 21 will be denoted with the same reference numerals.

An image processing device shown in FIG. 27 comprises image pickup means 11C with zoom and focus adjustment functions for taking images of objects within the field space, and outputting moving image signals and image pickup region information, the target-point detecting means 12 for detecting the position of a target point within a target, cropping position determining means 13D for determining a cropping position of a target based on the lens status information (focus distance information, lens power information) from the image pickup means 11C and the detected results of the target point position from the target-point detecting means 12, predetermined-sized image cropping means 14 for inputting moving image signals from the image pickup means 11C, and cropping a predetermined image size from the moving image signals based on the cropping position information from the cropping position determining means 13D, and cropped image output means 15 for converting cropped moving image signals with cropped predetermined image size into video signals in accordance with the specifications of a monitor or the like, or into a file format that can be reproduced on a personal computer or the like, and outputting these.

The image pickup means 11C with zoom and focus adjustment functions comprise the lens unit 111; the focus adjustment mechanism unit 112A for adjusting the position of a focus lens; the zoom adjustment mechanism unit 112B for adjusting the position of a zoom lens; the lens status control panel 112C for specifying and displaying a lens control status such as a focus status and zoom status; the lens control unit 112D for controlling the focus adjustment mechanism unit 112A and the zoom adjustment mechanism unit 112B for adjustment based on lens control status instructions; and the image pickup device and image pickup control unit 112E for controlling an image pickup device and a taken image thereof.

The cropping position determining means 13D comprises a relevant information generating unit 131C including the position storage flash memory 131B-1 for storing image-pickup-device plane coordinates information corresponding to the detected results of target point position information in the field coordinates, the size storage flash memory 131B-2 for storing the number of small images corresponding to a predetermined distance from near the position of a subject A for each field position information, a position information correcting unit 131B-3 for correcting the image-pickup-device plane coordinates information from the position storage flash memory 131B-1 based on the lens status information from the image pickup means 11C, and a size correcting unit 131B-4 for correcting the number of small images corresponding to a predetermined distance from near the position of the subject A from the size storage flash memory 131B-2 based on the lens status information from the image pickup means 11C; an image cropping position computing unit 133C for calculating a cropping position based on the image-pickup-device plane coordinates information corresponding to the detected results of the target-point position information, the number of small images corresponding to a predetermined distance from near the position of the subject A, and the size information from the target size information storing unit 132; and the target size information storing unit 132. The size information handled by the target size information storing unit 132 may be real target size information in the field, or target size information in a taken image.

With the aforementioned configuration, for example, even if zoom power varies, the field position information corresponding to the center pixel of a taken image does not vary in principle, and accordingly, the correlation between the field position and the image-pickup-device plane coordinates within an image is corrected in accordance with amount-of-change D of zoom power.

### Fifth Embodiment

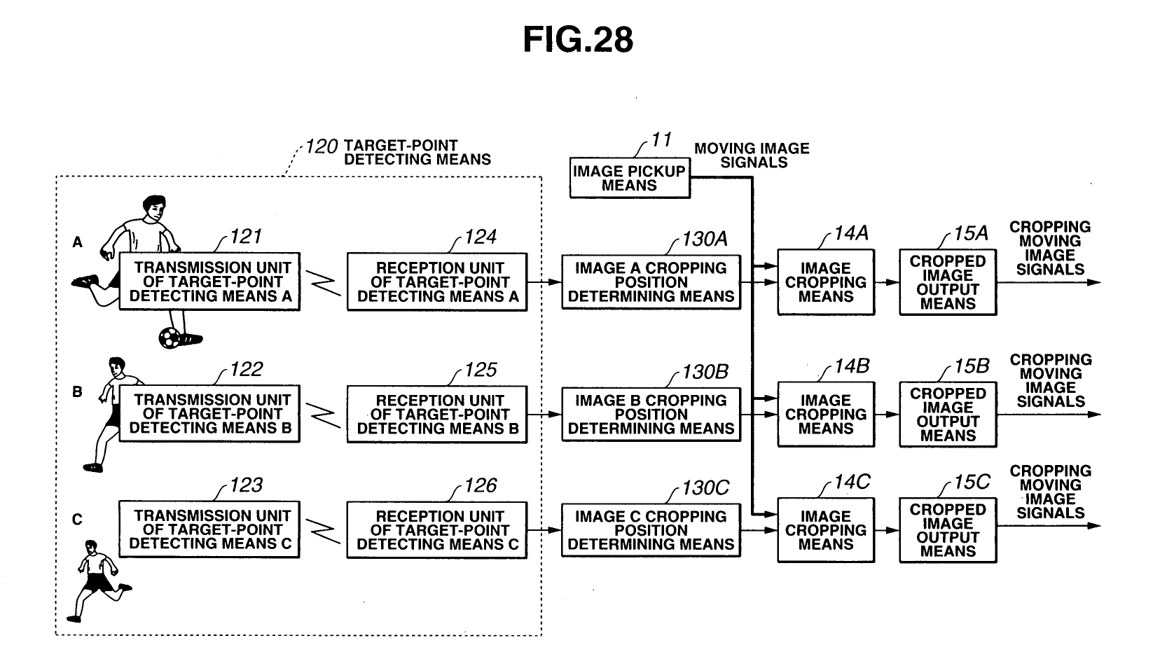

FIG. 28 is a block diagram illustrating the configuration of an image processing device according to a fifth embodiment of the present invention.

With the first through fourth embodiments, one player puts on positional detecting means (=target-point detecting means), a cropped image is output so as to follow the player alone.

With the fifth embodiment, multiple players put on position detecting means (i.e., target-point detecting means) respectively, multiple cropped images are output so as to follow each player.

An image processing device shown in FIG. 28 has a configuration wherein multiple (three in the drawing) target-point detecting means (transmission unit 121 and reception unit 124 of target-point detecting means A) (transmission unit 122 and reception unit 125 of target-point detecting means A) (transmission unit 123 and reception unit 126 for target-point detecting means A) are included therein, a cropping position corresponding to the position detected results of each target-point detecting means is determined by each image A cropping position determining means 130A, image B cropping position determining means 130B, or image C cropping position determining means 130C separately, subsequently, three image cropping means 14A, 14B, and 14C each crops the corresponding image A, B, or C from one moving image signal taken by the image pickup means 11 based on each determined cropping position of the image A, B, or C, and three cropped image output means 15A, 15B, or 15C each outputs a moving image signal corresponding to each cropped image separately.

More specifically, with the aforementioned configuration, players A, B, and C each puts on a transmitter having a GPS function which is the transmission unit 121 (for player A), 122 (for player B), or 123 (for player C) of the target-point detecting means, the transmission units 121 122, and 123 output each field position information, the reception units 124 (for player A), 125 (for player B), and 126 (for player C) of the target-point detecting means each receives the corresponding field position information, the image A cropping position determining means 130A, image B cropping position determining means 130B, and image C cropping position determining means 130C each assumes the corresponding player's region in the image pickup region of the image pickup means 11, each determines a cropping image so as to accommodate the entire body of the corresponding player, the image cropping means 14A (for player A), 14B (for player B), and 14C (for player C) each crops the corresponding cropping image, and the cropped image output means 15A (for player A), 15B (for player B), and 15C (for player C) each outputs the corresponding cropped image.

To avoid confusion, the transmission units 121, 122, and 123 each attaches identifiable ID information on the corresponding field position information at the time of outputting the corresponding field position information, whereby the reception units 124, 125, and 126 can track the corresponding target player A, B, or C by identifying the ID information without fail.

The cropped image output means 15A, 15B, and 15C output the corresponding image cropped by the corresponding image cropping means 14A, 14B or 14C as a different signal, whereby the output signal can be recorded by a recording device such as a DVD (Digital Video Disk) recorder simultaneously.

Also, an arrangement may be made wherein the configuration of the cropped image output means 15A, 15B, and 15C is changed to a 3-input and 1-selective output configuration, i.e., enabling one output selectively, whereby the cropped image output means 15A, 15B, and 15C select an output image of the images cropped by the image cropping means 14A, 14B, and 14C, and the selected one cropped image signal is output.

Also, an arrangement may be made wherein the configuration of the cropping image output means is changed to a 3-input and 1-selective output configuration, one output is selectively enabled, whereby the images cropped by the image cropping means 14A, 14B, and 14C can be synthesized to output one image signal.

While description has been made wherein the image cropping means 14A, 14B, and 14C are means different from the image pickup means 11, the configuration is not restricted to this. For example, an arrangement may be made wherein the image sensor of the image pickup means 11 includes a multiple scanning circuit for reading multiple partial regions in an image pickup region simultaneously, and this circuit has the corresponding multiple output lines, and the internal circuit of the image pickup means controls the image sensor to output multiple cropped images.

### Sixth Embodiment

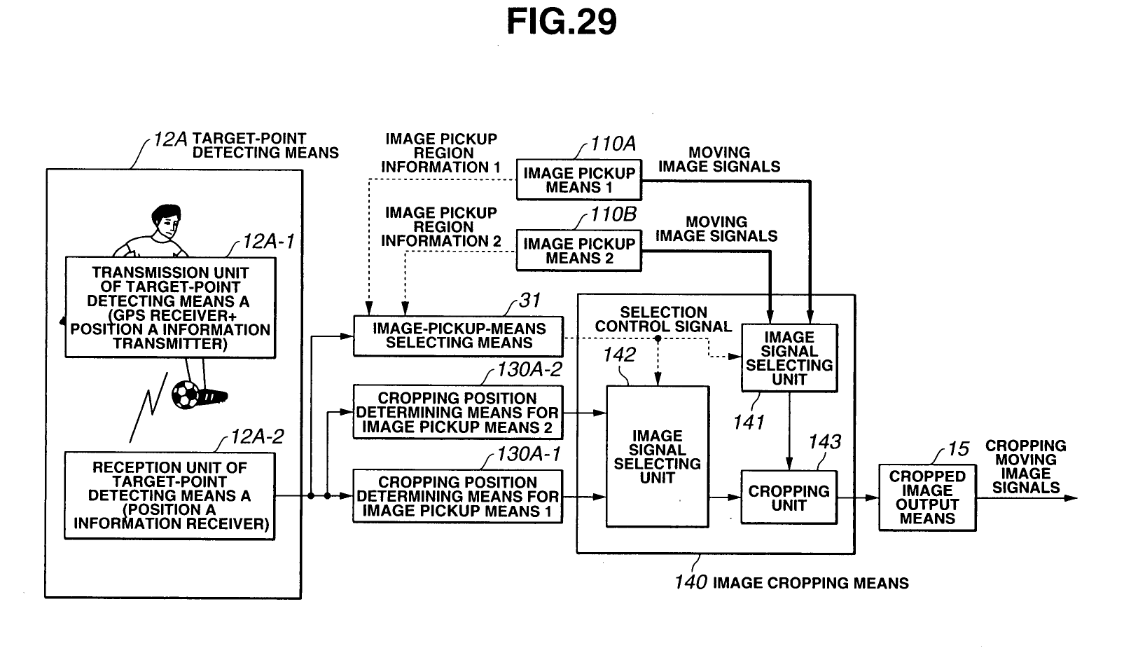

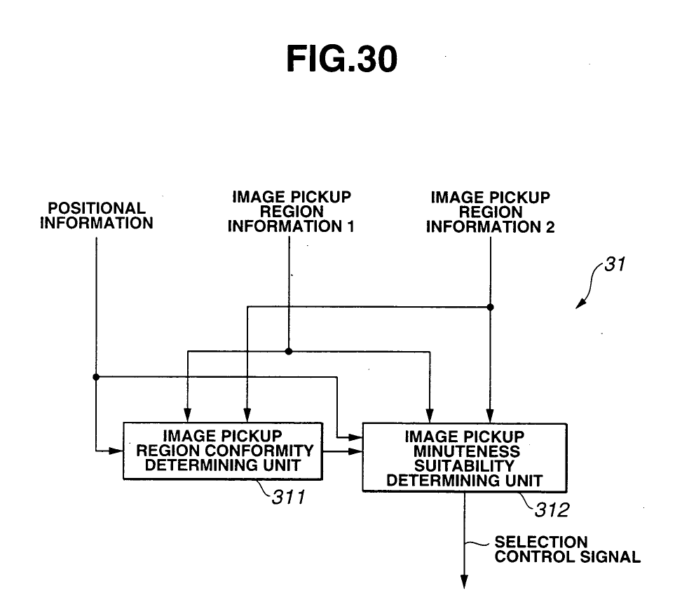

FIG. 29 is a block diagram illustrating the configuration of an image processing device according to a sixth embodiment of the present invention, and FIG. 30 is a block diagram illustrating the detailed configuration of the image-pickup-means selecting means shown in FIG. 29.

With the first through fifth embodiments, examples of one output (one cropped image output) for one image pickup means, or multiple outputs (multiple cropped images output) for one image pickup means have been described.

The sixth embodiment is an embodiment wherein from moving images taken by multiple image pickup means simultaneously, one cropped image is selected. Here, description will be made regarding an example wherein one cropped image of one image pickup means is selected and output from multiple image pickup means. As for multiple image pickup means, multiple image pickup means having a mutually different image pickup region, or multiple image pickup means having the mutually different number of pixels may be employed.

An image processing device shown in FIG. 29 comprises multiple (two in the drawing) image pickup means 110A and 110B for taking an image of a target within the field space, and outputting moving image signals and image pickup region information 1 and 2 respectively; the target-point detecting means 12A; two cropping position determining means 130A-1 and 130A-2 for the image pickup means 110A and 110B; image-pickup-means selecting means 31 for generating and outputting a selection control signal based on the position information from the target-point detecting means 12A, and the image pickup region information 1 and 2 from the image pickup means 110A and 110B; image cropping means 140; and cropped image output means 15.

The target-point detecting means 12A comprise the transmission unit 12A-1 of the target-point detecting means A, and the reception unit 12A-2 of the target-point detecting means A. The transmission unit 12A-1 of the target-point detecting means A comprises a GPS receiver, and a position-A information transmitter for transmitting position-A information obtained by the GPS receiver, for example. The reception unit 12A-2 comprises the position-A information receiver, for example.

With the GPS receiver in the transmission unit 12A-1 of the target-point detecting means 12A, detailed information regarding latitude and longitude can be calculated as field position information of the receiver. The field position information is transmitted from the position-A information transmitter, received by the position-A information receiver connected to an image cropping control function, the image cropping means 14 crops one moving image signal selected from the two moving image signals from the image pickup means 110A and 110B in accordance with one cropping position selected by the image-pickup-means selecting means from the two cropping positions determined by the cropping position determining means 130A-1 and 130A-2 based on the field position information, and the cropped image output means 15 converts the cropped moving image signals into video signals in accordance with the specifications of a monitor or the like, or into a file format that can be reproduced on a personal computer or the like, and outputs these.

The image cropping means 140 comprises an image selecting unit 141 for selecting one of the two moving image signals from the image pickup means 110A and 110B based on the selection control signal from the image-pickup-means selecting means 31; an image signal selecting unit 142 for selecting one of the two image cropping position signals corresponding to the image pickup mean 110A and 110B from the cropping position determining means 130A-1 and 130A-2 based on the selection control signal from the image-pickup-means selecting means 31; and a cropping unit 143 for cropping an image based on the cropping position selected by the image signal selecting unit 142 from the moving image signal selected by the image signal selecting unit 141.

The image-pickup-means selecting means 31, as shown in FIG. 30, comprises an image-pickup-region conformity determining unit 311 for inputting the position information of a target point (sensor) from the target-point detecting means 12A, and the image pickup region information 1 and 2 from the image pickup means 110A and 110B, and determining image pickup region compatibility based on these information; an image-pickup-minuteness suitability determining unit 312 for outputting a selection control signal for selecting a moving image signal with compatible image pickup region and suitable image pickup minuteness by inputting the position information of a target point (sensor) from the target-point detecting means 12A, the image pickup region information 1 and 2 from the image pickup means 110A and 110B, the image pickup region compatibility information from the image-pickup-region conformity determining unit 311, and determining image pickup minuteness suitability based on these information.

With the aforementioned configuration, in the event that the image pickup regions of the two image pickup means 110A and 110B are different and the position of a target point belongs to one of the image pickup regions, the image-pickup-region conformity determining unit 311 performs control so as to select the image pickup means of which image pickup region includes the target point.

Also, in the event that both the image pickup regions of the image pickup means 110A and 110B include a target point, the image-pickup-minuteness suitability determining unit 312 selects the image pickup means having more pixels to take an image of a player serving as a target with higher-minuteness.

With the first through third embodiments, description has been made regarding calibration, and the same method can be applied to a case of using multiple image pickup means. However, it is more preferable to perform calibration in multiple cameras simultaneously. In other words, the target-point detecting means 12A is moved to measuring points sequentially, and a position within an image of each image pickup means 110A and 110B should be identified for each image pickup means 110A and 110B.

Next, description will be made regarding placement settings of image pickup regions of multiple fixed image pickup means (cameras).

The multiple image pickup means comprise multiple cameras which differ from each other in at least one of the following; the region to be taken, the direction for image-taking, power, and depth of field, with the image cropping means selecting one of the multiple cameras according to the field coordinates of a target point detected by the target-point detecting means, and then the selected camera outputting taken image information.

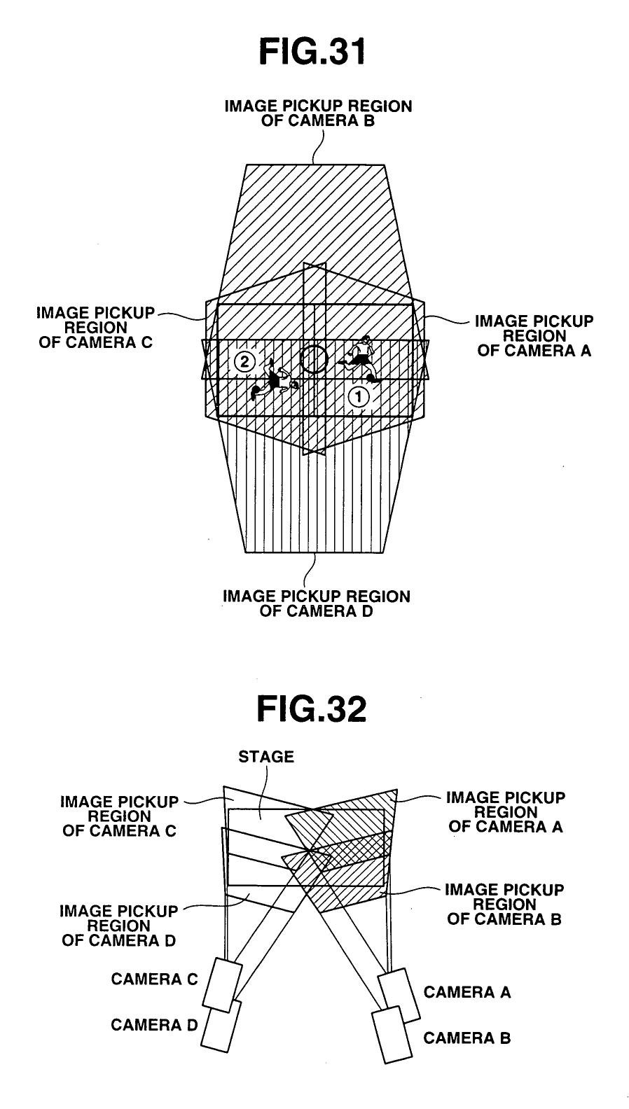

FIG. 31 illustrates, as an example of a sports field such as a soccer field, positional relations between cameras and players as viewed from above.

Focus adjustment including dispositions of cameras, lens power, and diaphragm adjustment are performed so as to divide the entire region to be taken such as a soccer field into each image pickup region of multiple cameras, and take an image of a target. Preferably, the image pickup region of each camera is overlapped with each other to avoid a case wherein an image of target 1 or 2 cannot be taken. The focus adjustment of each camera is performed by means of the settings of adjustment mechanism (focus control system) of each camera. The lens power of each camera is performed by means of the settings of optical zoom functions (zoom control system) of each camera.

Also, of directions of a camera indicating a range wherein an image of a target can be taken by a camera, in a depth direction there are a region in focus and a region out of focus as an image pickup region, and accordingly, a preferable image in focus can be output all the time by setting the image pickup region of each camera such that a region out of focus for one camera becomes a region in focus for another camera.

FIG. 32 illustrates, as an example of a hall such as a theater, positional relations between cameras and a stage as viewed from above.

In this case, in the same way, when taking images of different regions on the stage by using multiple cameras, an image pickup region corresponding to each camera is set so as to focus on a region in a different depth direction on the stage. Alternatively, multiple cameras are set such that the lens power of each camera is changed for each image pickup region in a different depth direction on the stage.

Next, description will be made regarding various kinds of method for detecting a target point.

A method for detecting a target point is not restricted to a GPS. There is a method wherein airwaves are employed such as with a wireless LAN (Local Area Network) or PHS (Personal Handyphone System), and the position of a target is detected by means of a transmitter thereof and a receiver thereof. Also, there are various wireless methods having no cable, such as light emission/reception including infrared light for example, and generation of sound and a microphone. Further, an arrangement may be made wherein a floor mat with pressure sensors is spread on a floor such as a stage, and the sensors in the mat detect a target moving on the mat by means of like a touch-panel.

In addition, various kinds of method including image processing, such as capturing change in temperature by means of an infrared camera, may be employed.

Also, the detecting method is not restricted to a single detecting method. For example, an arrangement may be made wherein rough detection is performed and detected results thereof are used, and further detailed detection is performed using another method, thereby combining multiple detecting methods.

For example, an arrangement may be made wherein rough detection is made with error of around 10 m by means of a GPS or the like, further, the positions of players are identified by means of image processing, and so forth. Detection may be performed by combining various kinds of methods taking into consideration high-speed processing and detection precision.

Also, when detecting a position more precisely with the aforementioned image processing than with wireless, a first camera is used as image pickup means, and a second camera having low-resolution is disposed near the first camera and used for detecting a rough position, whereby image processing can be performed at a high speed, further, employing the second camera simplifies the configuration of the first camera, whereby high-speed detection can be performed.

Also, in the event of employing multiple cameras, by employing one of the aforementioned multiple cameras used for image pickup means as the second camera, i.e., a camera for detecting a rough position, there is no need to employ another separate camera as described above solely for this purpose.

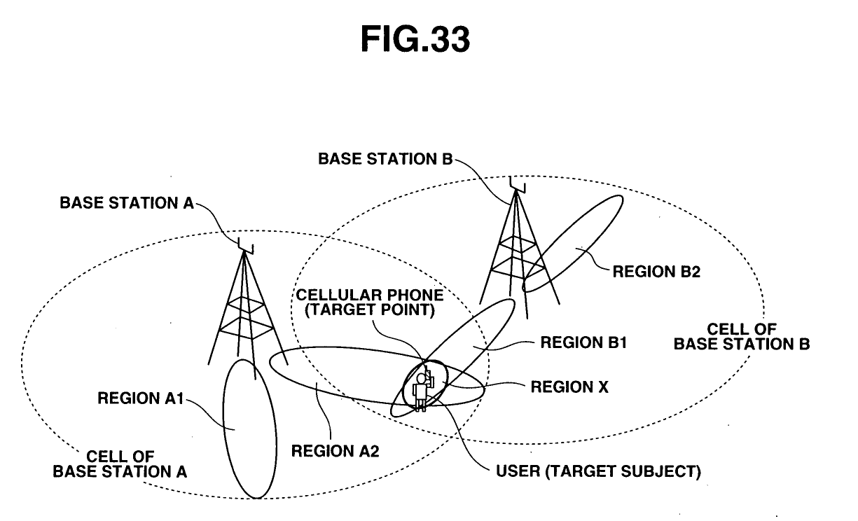

FIG. 33 is an explanatory diagram describing a method for detecting a target point using an adaptive array antenna. As for adaptive array antennas, an article describing adaptive array antennas ran in Nikkei Science, October 2003, pp 62-70.

Description will be now made regarding a method for detecting a target point using an adaptive array antenna. In FIG. 33, base stations A and B are base stations each including two adaptive antennas. As for the number of antennas, the greater the number of antennas is, the more detection precision improves, and accordingly increasing the number of antennas is preferable. These multiple antennas detect airwaves emitted from a cellular phone (target point) held by a user (target subject). Subsequently, the direction of the cellular phone, which emitted airwaves, can be obtained from the phase difference between airwaves detected by the multiple antennas. In FIG. 33, Regions A1 and A2 shown in FIG. 33 are directions obtained by the base station A, and regions B1 and B2 are directions obtained by the base station B. Here, the reason why two directions are obtained is that the multiple antennas making up an adaptive array antenna are disposed on a line, and accordingly, directions obtained from the phase difference received at the multiple antennas are two directions. If a camera handles these two directions, one base station is sufficient, however, in the event that there is the need to identify one direction alone, determination can be made that a region overlapped with regions obtained by each base station includes the cellular phone (target point) by employing multiple base stations (two in the drawing). In FIG. 33, determination can be made that a region X overlapped with the region A2 and region B1 includes the cellular phone (target point).

Thus, the relative position information of the cellular phone (target point) from the base stations can be obtained. Note that in general, information regarding the latitude, longitude, and height of each base station is known, and accordingly, the latitude, longitude, and height of the cellular phone (target point) can be obtained by using this information.

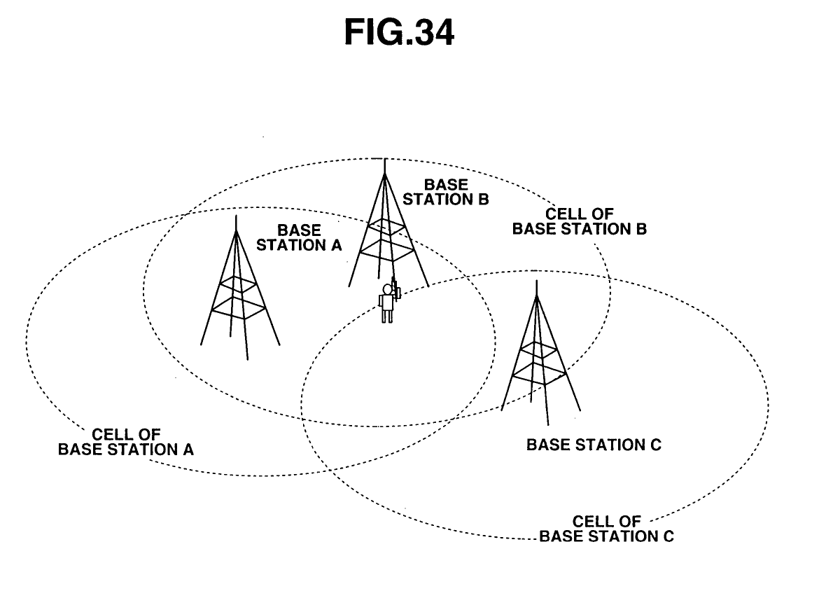

FIG. 34 is a diagram describing a method for detecting a target point using the intensity or time difference of airwaves from a cellular phone.

Multiple base stations (three in FIG. 34) detect airwaves emitted from a cellular phone (target point) held by a user (target subject). The intensity difference of airwaves detected by each base station, or the arrival time difference of the same airwaves (arrival time of airwaves) detected by each base station is detected here. In the event that the cellular phone (target point) is positioned near the base station, the intensity of airwaves becomes strong, and the arrival time of airwaves becomes fast (airwaves reach the base station from the cellular phone in a short period of time). Accordingly, the position of the cellular phone (target point) can be obtained based on the intensity difference of airwaves, or the arrival time difference of airwaves detected by each base station.

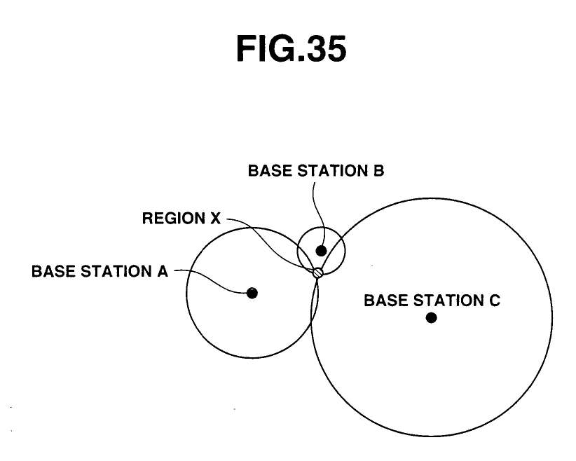

FIG. 35 is a diagram illustrating a method for obtaining the position of this target point. Circles are drawn centered on the position of each base station such that the radius thereof is equivalent to the intensity difference of airwaves, or the arrival time difference of airwaves detected by each base station. Here, the stronger the intensity of airwaves, or the faster the arrival time, the shorter the radius of the circle. Subsequently, determination can be made that a region X overlapped with each circle includes the cellular phone (target point).

Thus, the relative position information of the cellular phone (target point) from the base stations can be obtained. Note that in general, information regarding the latitude, longitude, and height of each base station is known, and accordingly, the latitude, longitude, and height of the cellular phone (target point) can be obtained by using this information.

Now, with a soccer match or the like, there are various needs for recording a goal scene, such as zooming in the goal scene, watching an image from various angles, and so forth.

In response to these demands, an arrangement may be made wherein, when a target point enters a predetermined image pickup area near the goal, this is detected to control starting of shooting. On the other hand, when the target point leaves the area, stopping of shooting is controlled. Further, with the present invention, a target is not detected by image pickup means but by a sensor, and accordingly, control of starting/stopping cropping corresponding to the position of the target allows power supplied to the image pickup means to be turned off at the time of the target being out of the image pickup region, thereby realizing lower electrical power consumption.

Also, when shooting continuously, a cropping region in a specific area may be reduced in size in order to raise magnifying power at a specific area, instead of controlling start/stop of cropping.

According to the image processing device of the present invention, the target-point detecting means using a sensor such as a GPS can recognize the image position of a target subject within image data taken by the image pickup means.

According to the present invention, an image pickup direction and image pickup size can be automatically changed without operations and labor of a camera operator, and also high-speed change that is difficult with human operations is allowed. When shooting is performed primarily using a fixed camera, the position and size of an image pickup region can be automatically changed and displayed at high speed accompanied by a target point moving.

Also, according to the present invention, an image can be cropped, adjusted, zoomed in and displayed while tracking a target.

Further, according to the present invention, a target in a moving image can automatically be tracked and output, and also a-target in a still image can be cropped and output with the immediate surroundings thereof.

The present invention can be widely applied to image processing devices in image pickup systems wherein a target is tracked and the image thereof is cropped.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. An image processing device comprising:
image pickup means for forming an image of a target using an optical system, then subsequently taking the image using an image pickup device, and obtaining image information including the target;
target-point detecting means for detecting the position in a field where a target point of the target exists as position information represented by information unrelated to the position where the image pickup means exists; and
relevant information generating means for obtaining relevant information representing the correlation between the position information detected by the target-point detecting means and the camera coordinates on the basis of the direction and/or field angle where the image pickup means takes an image.

2. An image processing device according to claim 1, further comprising focus control means for controlling the optical system such that the image of the target to be taken by the image pickup means focuses on the image pickup device plane.

3. An image processing device comprising:
image pickup means for forming an image of a target using an optical system, then subsequently taking the image using an image pickup device, and obtaining image information including the target;
target-point detecting means for detecting the position in a field where a target point of the target exists as position information represented by information unrelated to the position where the image pickup means exists; and
relevant information generating means for obtaining relevant information representing the correlation between the position information detected by the target-point detecting means and image-pickup-device plane coordinates where the image pickup means takes an image of the target.

4. An image processing device according to claim 1, wherein the coordinates of a position where the target point exists are field coordinates representing the absolute position where the target point exists within a field by means of coordinates.

5. An image processing device according to claim 3, wherein the coordinates of a position where the target point exists are field coordinates representing the absolute position where the target point exists within a field, by means of coordinates.

6. An image processing device according to claim 4, the target-point detecting means comprising:
field coordinates detecting means for detecting the field coordinates of a target, in order to measure the field coordinates of the target;
field coordinates information transmitting means for transmitting the field coordinates information measured by the field coordinates detecting means; and
field coordinates information receiving means for receiving the field coordinates information transmitted by the field coordinates transmitting means.

7. An image processing device according to claim 5, the target-point detecting means comprising:
field coordinates detecting means for detecting the field coordinates of a target, in order to measure the field coordinates of the target;
field coordinates information transmitting means for transmitting the field coordinates information measured by the field coordinates detecting means; and
field coordinates information receiving means for receiving the field coordinates information transmitted by the field coordinates transmitting means.

8. An image processing device according to claim 1, wherein the target-point detecting means comprises multiple target-point sensors each of which an address is assigned to for detecting the position of the target point,
wherein the coordinates of the position where the target point exists are the address number of the target-point sensor which detected the target point,
and wherein the relevant information generating means obtains the correlation between the position information and the camera coordinates using a conversion table indicating the correlation between the address number and field coordinates representing the absolute position where the target-point sensor exists within a field, by means of coordinates.

9. An image processing device according to claim 3, wherein the target-point detecting means comprises multiple target-point sensors each of which an address number is assigned to for detecting the position of the target point,
wherein the coordinates of the position where the target point exists are the address number of the target-point sensor which detected the target point,
and wherein the relevant information generating means obtains the correlation between the position information and the image-pickup-device plane coordinates using a conversion table indicating the correlation between the address number and the image-pickup-device plane coordinates where the target-point sensor is taken.

10. An image processing device according to claim 1, further comprises image cropping means for outputting the image information relating to a partial region of the image information obtained by the image pickup means based on the relevant information obtained by the relevant information generating means.

11. An image processing device according to claim 3, further comprising image cropping means for outputting the image information relating to a partial region of the image information obtained by the image pickup means based on the relevant information obtained by the relevant information generating means.

12. An image processing device according to claim 10, wherein the image cropping means outputs the image information relating to a partial region of the image information taken by the image pickup device.

13. An image processing device according to claim 11, wherein the image cropping means outputs the image information relating to a partial region of the image information taken by the image pickup device.

14. An image processing device according to claim 10, wherein the image information output by the image cropping means is the image information with a predetermined area centered on a point corresponding to the target point detected by the target-point detecting means, of the image information obtained by the image pickup means.

15. An image processing device according to claim 11, wherein the image information output by the image cropping means is the image information with a predetermined area centered on a point corresponding to the target point detected by the target-point detecting means, of the image information obtained by the image pickup means.

16. An image processing device according to claim 14, further comprising target size information storing means for storing the size of the target within the field space,
wherein the image cropping means reads out the target size relating to the target point detected by the target-point detecting means from the target size information storing means, and this readout target size is converted into image-pickup-device plane coordinates based on the relevant information of the coordinates obtained by the relevant information generating means to obtain the size of the predetermined area.

17. An image processing device according to claim 15, further comprising target size information storing means for storing the size of the target within the field space,
wherein the image cropping means reads out the target size relating to the target point detected by the target-point detecting means from the target size information storing means, and this readout target size is converted into image-pickup-device plane coordinates based on the relevant information of the coordinates obtained by the relevant information generating means to obtain the size of the predetermined area.

18. An image processing device according to claim 10, wherein the image information output by the image cropping means is the image information of the region surrounded by a polygon of which apexes are the target points detected by the target-point detecting means, of the image information obtained by the image pickup means.

19. An image processing device according to claim 11, wherein the image information output by the image cropping means is the image information of the region surrounded by a polygon of which apex is the target point detected by the target-point detecting means, of the image information obtained by the image pickup means.

20. An image processing device according to claim 10, wherein the image information output by the image cropping means is the image information of the region including all of the multiple target points detected by the target-point detecting means, out of the image information obtained by the image pickup means.

21. An image processing device according to claim 11, wherein, the image information output by the image cropping means is the image information of the region including all of the multiple target points detected by the target-point detecting means of the image information obtained by the image pickup means.

22. An image processing device according to claim 10, wherein the relevant information generating means generates the relevant information at the time of startup of the image processing device,
and wherein the image cropping means outputs the image information relating to a partial region of the image information obtained by the image pickup means based on the relevant information that the relevant information generating means obtains at the time of startup.

23. An image processing device according to claim 11, wherein the relevant information generating means generates the relevant information at the time of startup of the image processing device,
and wherein the image cropping means outputs the image information relating to a partial region of the image information obtained by the image pickup means based on the relevant information that the relevant information generating means obtains at the time of startup.

24. An image processing device according to claim 4, wherein the relevant information generating means obtains the relevant information between the field coordinates and the image-pickup-device plane coordinates where the image pickup means takes an image based on the relevant information between the field coordinates detected by the target-point detecting means and the camera coordinates on the basis of the direction and/or field angle where the image pickup means takes an image.

25. An image processing device according to claim 5, wherein the relevant information generating means obtains the relevant information between the field coordinates and the image-pickup-device plane coordinates where the image pickup means takes an image based on the relevant information between the field coordinates detected by the target-point detecting means and the camera coordinates on the basis of the direction and/or field angle where the image pickup means takes an image.

26. An image processing device according to claim 24, wherein the camera coordinates are three-dimensional coordinates of which the origin is the center position of incident pupil of the optical system, represented by one axis serving as a primary ray passing through the origin and the center of the image pickup device plane, and two axes orthogonal to each other and to that axis, the camera coordinates being different from the field coordinates.

27. An image processing device according to claim 25, wherein the camera coordinates are three-dimensional coordinates of which the origin is the center position of incident pupil of the optical system, represented by one axis serving as a primary ray passing through the origin and the center of the image pickup device plane, and two axes orthogonal to each other and to that axis, the camera coordinates being different from the field coordinates.

28. An image processing device according to claim 26, wherein the relevant information generating means obtains the relevant information by using a conversion expression for converting the field coordinates into the camera coordinates.

29. An image processing device according to claim 27, wherein the relevant information generating means obtains the relevant information by using a conversion expression for converting the field coordinates into the camera coordinates.

30. An image processing device according to claim 28, wherein the conversion expression that the relevant information generating means employs is switched according to the magnification of the optical system.

31. An image processing device according to claim 29, wherein the conversion expression that the relevant information generating means employs is switched according to the magnification of the optical system.

32. An image processing device according to claim 3, wherein the image-pickup-device plane coordinates are coordinates represented by 2 axes identifying a position within an image pickup device plane where the image pickup means takes an image.

33. An image processing device according to claim 26, wherein the relevant information generating means obtains the relevant information by using a conversion table for converting the field coordinates into the camera coordinates.

34. An image processing device according to claim 27, wherein the relevant information generating means obtains the relevant information by using a conversion table for converting the field coordinates into the camera coordinates.

35. An image processing device according to claim 33, wherein the conversion table that the relevant information generating means employs is switched according to the magnification of the optical system.

36. An image processing device according to claim 34, wherein the conversion table that the relevant information generating means employs is switched according to the magnification of the optical system.

37. An image processing device according to claim 10, wherein the image-pickup-device plane coordinates divide the entire view angle where the image pickup means takes an image into multiple small view angles,
and wherein the image cropping means selects the field angle to be read out from the multiple small view angles based on the relevant information of the coordinates obtained by the relevant information generating means, outputs the image information relating to the selected view angle, out of the image information obtained by the image pickup means.

38. An image processing device according to claim 11, wherein the image-pickup-device plane coordinates divide the entire view angle where the image pickup means takes an image into multiple small view angles,
and wherein the image cropping means selects the field angle to be read out from the multiple small view angles based on the relevant information of the coordinates obtained by the relevant information generating means, outputs the image information relating to the selected view angle, of the image information obtained by the image pickup means.

39. An image processing device according to claim 10, further comprising image information recording means for recording the field coordinates of the target point detected by the target-point detecting means or the image-pickup-device plane coordinates as well as the image information obtained by the image pickup means,
wherein the image cropping means additionally reads out the field coordinates value of the target point or the image-pickup-device plane coordinates at the time of reading out the image information recorded by the image information recording means, and outputs the image information relating to a partial region of the readout image information according to the readout field coordinates value or image-pickup-device plane coordinates.

40. An image processing device according to claim 11, further comprising image information recording means for recording the field coordinates of the target point detected by the target-point detecting means or the image-pickup-device plane coordinates as well as the image information obtained by the image pickup means,
wherein the image cropping means additionally reads out the field coordinates value of the target point or the image-pickup-device plane coordinates at the time of reading out the image information recorded by the image information recording means, and outputs the image information relating to a partial region of the readout image information according to the readout field coordinates value or image-pickup-device plane coordinates.

41. An image processing device according to claim 10, further comprising image information recording means for recording the image information obtained by the image pickup means, the field coordinates of the target point detected by the target-point detecting means, the camera coordinates, and the relevant information obtained by the relevant information generating means,
wherein the image cropping means additionally reads out the field coordinates value of the target point, the camera coordinates, and the relevant information at the time of reading out the image information recorded by the image information recording means, and outputs the image information relating to a partial region of the readout image information according to the readout field coordinates of the target point, camera coordinates, and relevant information.

42. An image processing device according to claim 11, further comprising image information recording means for recording the image information obtained by the image pickup means, the field coordinates of the target point detected by the target-point detecting means, the camera coordinates, and the relevant information obtained by the relevant information generating means,
wherein the image cropping means additionally reads out the field coordinates value of the target point, the camera coordinates, and the relevant information at the time of reading out the image information recorded by the image information recording means, and outputs the image information relating to a partial region of the readout image information according to the readout field coordinates of the target point, camera coordinates, and relevant information.

43. An image processing device according to claim 6, wherein the field coordinates detecting means is means capable of measuring the latitude, longitude, and altitude of the target point by means of a GPS (Global Positioning System),
and wherein the field coordinates are coordinates represented by at least two of the measured latitude, longitude, and altitude.

44. An image processing device according to claim 7, wherein the field coordinates detecting means is means capable of measuring the latitude, longitude, and altitude of the target point by means of a GPS (Global Positioning System),
and wherein the field coordinates are coordinates represented by at least two of the measured latitude, longitude, and altitude.

45. An image processing device according to claim 4, wherein the target-point detecting means is means for measuring the field coordinates of the target point as to multiple base stations by means of triangulation based on the intensity difference or arrival time difference of airwaves emitted from the multiple base stations,
and wherein the field coordinates are coordinates indicating the position of the measured target point as to the multiple base stations.

46. An image processing device according to claim 5, wherein the target-point detecting means is means for measuring the field coordinates of the target point as to multiple base stations by means of triangulation based on the intensity difference or arrival time difference of airwaves emitted from the multiple base stations,
and wherein the field coordinates are coordinates indicating the position of the measured target point as to the multiple base stations.

47. An image processing device according to claim 4, wherein the target-point detecting means is means for measuring the field coordinates of the target point as to multiple base stations by means of triangulation based on the intensity difference or arrival time difference of airwaves emitted from the target point,
and wherein the field coordinates are coordinates indicating the position of the measured target point as to the multiple base stations.

48. An image processing device according to claim 5, wherein the target-point detecting means is means for measuring the field coordinates of the target point as to multiple base stations by means of triangulation based on the intensity difference or arrival time difference of airwaves emitted from the target point,
and wherein the field coordinates are coordinates indicating the position of the measured target point as to the multiple base stations.

49. An image processing device according to claim 6, wherein the field coordinates detecting means is a group of pressure-sensitive sensors disposed with equal intervals, and the pressure-sensitive sensors on which the target rides detect the target, thereby measuring the position of the target above the sensor group,
and wherein the field coordinates are coordinates indicating the position of the measured target above the pressure-sensitive sensor group.

50. An image processing device according to claim 7, wherein the field coordinates detecting means is a group of pressure-sensitive sensors disposed with equal intervals, and the pressure-sensitive sensors on which the target rides detect the target, thereby measuring the position of the target above the sensor group,
and wherein the field coordinates are coordinates indicating the position of the measured target above the pressure-sensitive sensor group.

51. An image processing device according to claim 4, wherein the target has information transmitting means for transmitting information indicating its own present position,
and wherein the target-point detecting means measures the field coordinates of the information transmitting means as to the target-point detecting means based on the information transmitted by the information transmitting means.

52. An image processing device according to claim 5, wherein the target has information transmitting means for transmitting information indicating its own present position,
and wherein the target-point detecting means measures the field coordinates of the information transmitting means as to the target-point detecting means based on the information transmitted by the information transmitting means.

53. An image processing device according to claim 51, wherein the information transmitting means transmits airwaves having a predetermined frequency as information indicating its own present position,
wherein the target-point detecting means is an adaptive array antenna for receiving the transmitted airwaves,
wherein multiple antennas making up the adaptive array antenna detect the phase difference of the airwaves transmitted by the information transmitting means,
and wherein the direction in which the target point that has transmitted the airwaves exists within the field is detected based on the detected phase difference.

54. An image processing device according to claim 52, wherein the information transmitting means transmits airwaves having a predetermined frequency as information indicating its own present position,
wherein the target-point detecting means is an adaptive array antenna for receiving the transmitted airwaves,
wherein multiple antennas making up the adaptive array antenna detect the phase difference of the airwaves transmitted by the information transmitting means,
and wherein the direction in which the target point that has transmitted the airwaves exists within the field is detected based on the detected phase difference.

55. An image processing device according to claim 53, wherein the target-point detecting means comprises multiple adaptive array antennas,
and wherein the field coordinates of the information transmitting means as to the target-point detecting means are measured by performing triangulation based on the direction in which the target point that has transmitted the airwaves exists in the field, detected by the multiple adaptive array antennas.

56. An image processing device according to claim 54, wherein the target-point detecting means comprises multiple adaptive array antennas,
and wherein the field coordinates of the information transmitting means as to the target-point detecting means are measured by performing triangulation based on the direction in which the target point that has transmitted the airwaves exists in the field, detected by the multiple adaptive array antennas.

57. An image processing device according to claim 51, wherein the information transmitting means transmits ultrasonic waves having a predetermined frequency,
and wherein the target-point detecting means receives the ultrasonic waves transmitted by the information transmitting means at multiple points, performs triangulation, and measures the field coordinates of the information transmitting means as to the target-point detecting means.

58. An image processing device according to claim 52, wherein the information transmitting means transmits ultrasonic waves having a predetermined frequency,
and wherein the target-point detecting means receives the ultrasonic waves transmitted by the information transmitting means at multiple points, performs triangulation, and measures the field coordinates of the information transmitting means as to the target-point detecting means.

59. An image processing device according to claim 51, wherein the information transmitting means transmits infrared light at a predetermined flashing cycle,
and wherein the target-point detecting means receives the infrared light transmitted by the information transmitting means at multiple points, performs triangulation, and measures the field coordinates of the information transmitting means as to the target-point detecting means.

60. An image processing device according to claim 52, wherein the information transmitting means transmits infrared light at a predetermined flashing cycle,
and wherein the target-point detecting means receives the infrared light transmitted by the information transmitting means at multiple points, performs triangulation, and measures the field coordinates of the information transmitting means as to the target-point detecting means.

61. An image processing device according to claim 4, further comprising at least one distance measurement camera of which the positional relation as to the image pickup means is known,
wherein the target-point detecting means measures the field coordinates of the target point as to the distance measurement camera and the image pickup means by performing triangulation on the target point with the distance measurement camera and the image pickup means.

62. An image processing device according to claim 5, further comprising at least one distance measurement camera of which the positional relation as to the image pickup means is known,
wherein the target-point detecting means measures the field coordinates of the target point as to the distance measurement camera and the image pickup means by performing triangulation on the target point with the distance measurement camera and the image pickup means.

63. An image processing device according to claim 24, further comprising a position detection sensor for detecting the field coordinates of at least two points on the primary ray passing through the incident pupil center position of the optical system and the center of the image pickup device plane, of which the positional relation as to the image pickup means is known, and the field coordinates of at least one point except for on the line parallel to the primary ray,
wherein the relevant information generating means obtains the relevant information between the field coordinates detected by the target-point detecting means and the image-pickup-device plane coordinates where the image pickup means takes an image based on the correlation between the field coordinates values of the position detection sensors of at least three points and the camera coordinates.

64. An image processing device according to claim 25, further comprising a position detection sensor for detecting the field coordinates of at least two points on the primary ray passing through the incident pupil center position of the optical system and the center of the image pickup device plane, of which the positional relation as to the image pickup means is known, and the field coordinates of at least one point except for on the line parallel to the primary ray,
wherein the relevant information generating means obtains the relevant information between the field coordinates detected by the target-point detecting means and the image-pickup-device plane coordinates where the image pickup means takes an image based on the correlation between the field coordinates values of the position detection sensors of at least three points and the camera coordinates.

65. An image processing device according to claim 24, further comprising a position detection sensor for detecting the field coordinates of at least one point on the primary ray passing through the incident pupil center position of the optical system and the center of the image pickup device plane, of which the positional relation as to the image pickup means is known, the field coordinates of at least one point positioned within an image pickup region where the image pickup means takes an image and also positioned on the primary ray, and the field coordinates of at least one point except for the primary ray,
wherein the relevant information generating means obtains a conversion expression for converting the field coordinates detected by the target-point detecting means into the image-pickup-device plane coordinates where the image pickup means takes an image based on the relevant information between the field coordinates values of the position detection sensors of at least three points and the camera coordinates, as the relevant information.

66. An image processing device according to claim 25, further comprising a position detection sensor for detecting the field coordinates of at least one point on the primary ray passing through the incident pupil center position of the optical system and the center of the image pickup device plane, of which the positional relation as to the image pickup means is known, the field coordinates of at least one point positioned within an image pickup region where the image pickup means takes an image and also positioned on the primary ray, and the field coordinates of at least one point except for the primary ray,
wherein the relevant information generating means obtains a conversion expression for converting the field coordinates detected by the target-point detecting means into the image-pickup-device plane coordinates where the image pickup means takes an image based on the relevant information between the field coordinates values of the position detection sensors of at least three points and the camera coordinates as the relevant information.

67. An image processing device according to claim 10, wherein the image cropping means starts output of the image information relating to a partial region of the image information obtained by the image pickup means when the target-point detecting means detects the field coordinates of the target point within a predetermined specific region in a field.

68. An image processing device according to claim 11, wherein the image cropping means starts output of the image information relating to a partial region of the image information obtained by the image pickup means when the target-point detecting means detects the field coordinates of the target point within a predetermined specific region in a field.

69. An image processing device according to claim 10, wherein the image pickup means comprises multiple cameras which differ from each other in at least one of the region to be taken, the direction for image-taking, power, and depth of field, wherein an image can be picked up,
and wherein the image cropping means selects one camera from the multiple cameras according to the field coordinates of the target point detected by the target-point detecting means, and outputs the image information taken by the selected camera.

70. An image processing device according to claim 11, wherein the image pickup means comprises multiple cameras which differ from each other in at least one of the region to be taken, the direction for image-taking, power, and depth of field, wherein an image can be picked up,
and wherein the image cropping means selects one camera from the multiple cameras according to the field coordinates of the target point detected by the target-point detecting means, and outputs the image information taken by the selected camera.

71. An image processing device according to claim 69, wherein in the event that the target point exists on an overlapped region of the image pickup regions of the multiple cameras, the image cropping means selects a camera having a greater number of pixels to take an image of the target from the cameras corresponding to the overlapped region.

72. An image processing device according to claim 70, wherein in the event that the target point exists on an overlapped region of the image pickup regions of the multiple cameras, the image cropping means selects a camera having a greater number of pixels to take an image of the target from the cameras corresponding to the overlapped region.

73. An image processing device according to claim 6, wherein the field coordinates information transmitting means transmits the ID information of the target as well as the field information of the target point relating to the target.

74. An image processing device according to claim 7, wherein the field coordinates information transmitting means transmits the ID information of the target as well as the field information of the target point relating to the target.

75. An image processing device according to claim 10, further comprising lens control means for controlling the optical status of the image pickup means,
wherein the image cropping means corrects the size of a region of the image information to be output according to an optical status controlled by the lens control means.

76. An image processing device according to claim 11, further comprising lens control means for controlling the optical status of the image pickup means,
wherein the image cropping means corrects the size of a region of the image information to be output according to an optical status controlled by the lens control means.

77. An image processing device according to claim 4, further comprising lens control means for controlling the optical status of the image pickup means,
wherein, in the event that the image-pickup-device plane coordinates corresponding to the field coordinates of the target point detected by the target-point detecting means are out of the coordinates range where the image pickup means can take an image, the lens control means controls the optical status of the image pickup means so as to become the view angle of a wide direction.

78. An image processing device according to claim 5, further comprising lens control means for controlling the optical status of the image pickup means,
wherein, in the event that the image-pickup-device plane coordinates corresponding to the field coordinates of the target point detected by the target-point detecting means are out of the coordinates range where the image pickup means can take an image, the lens control means controls the optical status of the image pickup means so as to become the view angle of an wide direction.

79. A calibration method of an image processing device according to claim 33 for obtaining a conversion table, the calibration method comprising:
a first step for disposing target points at predetermined intervals within the field;
a second step for obtaining the field coordinates of the disposed target points;
a third step for taking an image of the target points disposed at the predetermined intervals by means of the image pickup means; and
a fourth step for generating the conversion table by correlating the field coordinates obtained in the second step with the image-pickup-device plane coordinates in the image taken in the third step for each target point disposed in the first step.

80. A calibration method of an image processing device according to claim 34 for obtaining a conversion table, the calibration method comprising:
a first step for disposing target points at predetermined intervals within the field;
a second step for obtaining the field coordinates of the disposed target points;
a third step for taking an image of the target point disposed at the predetermined intervals by means of the image pickup means; and
a fourth step for generating the conversion table by correlating the field coordinates obtained in the second step with the image-pickup-device plane coordinates in the image taken in the third step for each target point disposed in the first step.

81. A calibration method of an image processing device according to claim 63 for obtaining a conversion expression, the calibration method comprising:
a first step for disposing at least one target point on the primary ray passing through the incident pupil center position of the optical system and the center of the image pickup device plane, and at least one target point other than on the primary ray within an image pickup region where the image pickup means takes an image within the field;
a second step for obtaining the field coordinates of at least the two disposed target points;
a third step for taking images of at least the two target points disposed by means of the image pickup means; and
a fourth step for creating the conversion expression based on the relevant information between the field coordinates obtained from the field coordinates value of at least one target point on the primary ray of which positional relation as to the image pickup means is known, and the field coordinates values of at least two target points obtained in the second step, and the camera coordinates, and the relevant information between the field coordinates values of at least two target points in the image taken in the third step and the image-pickup-device plane coordinates.

82. A calibration method of an image processing device according to claim 64 for obtaining a conversion expression, the calibration method comprising:
a first step for disposing at least one target point on the primary ray passing through the incident pupil center position of the optical system and the center of the image pickup device plane, and at least one target point other than on the primary ray within an image pickup region where the image pickup means takes an image within the field;
a second step for obtaining the field coordinates of at least the two disposed target points;
a third step for taking images of at least the two target points disposed by means of the image pickup means; and
a fourth step for creating the conversion expression based on the relevant information between the field coordinates obtained from the field coordinates value of at least one target point on the primary ray of which positional relation as to the image pickup means is known, and the field coordinates values of at least two target points obtained in the second step, and the camera coordinates, and the relevant information between the field coordinates values of at least two target points in the image taken in the third step and the image-pickup-device plane coordinates.

83. A calibration method of an image processing device according to claim 65 for obtaining a conversion expression, the calibration method comprising:
a first step for disposing at least one target point on the primary ray passing through the incident pupil center position of the optical system and the center of the image pickup device plane, and at least one target point other than on the primary ray within an image pickup region where the image pickup means takes an image within the field;
a second step for obtaining the field coordinates of at least the two disposed target points;
a third step for taking images of at least the two target points disposed by means of the image pickup means; and
a fourth step for creating the conversion expression based on the relevant information between the field coordinates obtained from the field coordinates value of at least one target point on the primary ray of which positional relation as to the image pickup means is known, and the field coordinates values of at least two target points obtained in the second step, and the camera coordinates, and the relevant information between the field coordinates values of at least two target points in the image taken in the third step and the image-pickup-device plane coordinates.

84. A calibration method of an image processing device according to claim 66 for obtaining a conversion expression, the calibration method comprising:
a first step for disposing at least one target point on the primary ray passing through the incident pupil center position of the optical system and the center of the image pickup device plane, and at least one target point other than on the primary ray within an image pickup region where the image pickup means takes an image within the field;
a second step for obtaining the field coordinates of at least the two disposed target points;
a third step for taking images of at least the two target points disposed by means of the image pickup means; and
a fourth step for creating the conversion expression based on the relevant information between the field coordinates obtained from the field coordinates value of at least one target point on the primary ray of which positional relation as to the image pickup means is known, and the field coordinates values of at least two target points obtained in the second step, and the camera coordinates, and the relevant information between the field coordinates values of at least two target points in the image taken in the third step and the image-pickup-device plane coordinates.

85. An image processing device comprising:
image picked-up data input means for inputting image information including an image of the target obtained by forming an image of the target using an optical system, and then taking an image of the target;
field coordinates input means for inputting the field coordinates of the position where the target point exists within the field; and
relevant information generating means for obtaining the relevant information between the field coordinates input from the field coordinates input means and the coordinates within an image plane in the image information input from the image picked-up data input means.

86. An image processing program for controlling a computer so as to function as:
image picked-up data input means for inputting image information including an image of the target obtained by forming an image of the target using an optical system, and then taking an image of the target;
field coordinates input means for inputting the field coordinates of the position where the target point exists within the field; and
relevant information generating means for obtaining the relevant information between the field coordinates input from the field coordinates input means and the coordinates within an image plane in the image information input from the image picked-up data input means.
